(19) United States
(12) Patent Application Publication
(10) Pub. No.: US 2025/0278923 A1
(43) Pub. Date: Sep. 4, 2025

(54) INFORMATION PROCESSING METHOD IN INFORMATION PROCESSING DEVICE, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventors: Tatsumi NAGASHIMA, Osaka (JP); Kotaro SAKATA, Osaka (JP)

(21) Appl. No.: 19/213,008

(22) Filed: May 20, 2025

Related U.S. Application Data
(63) Continuation of application No. PCT/JP2023/026516, filed on Jul. 20, 2023.

(30) Foreign Application Priority Data
Nov. 25, 2022 (JP) 2022-188533

(51) Int. Cl. G06V 10/764; G06Q 10/0631; G06V 10/75; G06V 20/50

(52) U.S. Cl. CPC G06V 10/764; G06Q 10/063116; G06V 10/751; G06V 20/50

(57) ABSTRACT

An information processing method acquires a first image obtained by capturing a plurality of bonding targets and an installation date and time of each of the plurality of bonding targets, acquires a second image obtained by capturing the plurality of bonding targets after imaging of the first image and acquires an imaging date and time when the imaging has been performed, calculates a scheduled completion date and time of each of the plurality of bonding targets based on the installation date and time, decides, for each of the bonding targets, a position of the imaging date and time on a time axis from the installation date and time to the scheduled completion date and time, and decides color information for the decided position, and generates a superimposed image in which the color information is superimposed on each of the plurality of bonding targets included in the second image.

### FIELD OF INVENTION

The present disclosure relates to an information processing method in an information processing device, an information processing device, and an information processing program.

### BACKGROUND ART

Patent Literature 1 discloses a control device that subdivides, into meshes, a video sent from a video camera that photographs a concrete casting site, manages an elapsed time from the completion of concrete casting for each mesh, and color-codes the mesh for each stage according to the elapsed time from the completion of concrete casting.

In the technique disclosed in Patent Literature 1, since the mesh is not partitioned for each construction member, there is a problem that the degree of completion for each construction member cannot be recognized.

Patent Literature 1: JP 2011-202383 A

### SUMMARY OF THE INVENTION

The present disclosure has been made to solve such a problem, and an object of the present disclosure is to provide a technique of presenting a degree of completion of each of a plurality of bonding targets in a visually recognizable manner.

An information processing method according to one aspect of the present disclosure is an information processing method in an information processing device, the method including: acquiring a first image obtained by capturing a plurality of bonding targets and an installation date and time of each of the plurality of bonding targets; recognizing the plurality of bonding targets included in the first image; acquiring a second image obtained by capturing the plurality of bonding targets after imaging of the first image and acquiring an imaging date and time when the imaging has been performed; calculating a scheduled completion date and time of each of the plurality of bonding targets based on the installation date and time; deciding, for each of the bonding targets, a position of the imaging date and time on a time axis from the installation date and time to the scheduled completion date and time, and deciding color information predetermined for the decided position; generating a superimposed image in which the color information is superimposed on each of the plurality of bonding targets included in the second image based on a recognition result of the first image; and outputting the superimposed image.

According to the present disclosure, it is possible to present the degree of completion of a plurality of bonding targets in a visually recognizable manner.

### BRIEF DESCRIPTION OF THE DRAWINGS

FIG. 1 is a block diagram illustrating an example of an overall configuration of an information processing system according to a first embodiment of the present disclosure.

FIG. 2 is a sequence diagram illustrating an example of an overall image of processing of the information processing system in the first embodiment.

FIG. 3 is a view illustrating an example of a first image.

FIG. 4 is a view illustrating a state in which an ID is assigned to each construction member in the first image.

FIG. 5 is a view illustrating an example of a second image.

FIG. 6 is a view illustrating an example of a construction member list.

FIG. 7 is a view illustrating an example of a completion time list in the first embodiment.

FIG. 8 is a view illustrating an example of color map information.

FIG. 9 is a view illustrating an example of a superimposed image according to the first embodiment.

FIG. 10 is a view illustrating an example of an input screen according to a first modification of the first embodiment.

FIG. 11 is a view illustrating an example of a base image in a third modification of the first embodiment.

FIG. 12 is a view illustrating an example of a first image according to a fifth modification of the first embodiment.

FIG. 13 is a view illustrating an example of the first image according to the fifth modification of the first embodiment.

FIG. 14 is a view illustrating an example of a second image according the fifth modification of the first embodiment.

FIG. 15 is a block diagram illustrating an example of an overall configuration of an information processing system according to a second embodiment of the present disclosure.

FIG. 16 is a view illustrating an example of a data configuration of weather information.

FIG. 17 is a view illustrating an example of construction diagram information.

FIG. 18 is a view schematically illustrating a state in which a first worker performs mapping of each construction member through the input screen.

FIG. 19 is a view illustrating an example of a completion time list in the second embodiment.

FIG. 20 is a view illustrating an example of a superimposed image according to the second embodiment.

FIG. 21 is a flowchart illustrating an example of processing according to the second embodiment.

FIG. 22 is a flowchart illustrating an example of processing according to a first modification of the second embodiment.

FIG. 23 is a flowchart illustrating an example of processing according to a second modification of the second embodiment.

FIG. 24 is a view illustrating an example of a data configuration of a recommended information list.

FIG. 25 is a view illustrating an example of a superimposed image according to a third embodiment.

FIG. 26 is a flowchart illustrating an example of processing according to the third embodiment.

FIG. 27 is a flowchart illustrating an example of processing according to a first modification of the third embodiment.

FIG. 28 is a flowchart illustrating an example of processing according to a second modification of the third embodiment.

FIG. 29 is a view illustrating an example of a superimposed image according a third modification of the third embodiment.

### DETAILED DESCRIPTION

### Background of Present Disclosure

At a work site under construction (hereinafter, simply referred to as a work site), a plurality of bonding targets may be bonded to the base member. For example, a plurality of construction members may be bonded to the base member. In addition, at the work site, a plurality of construction companies may perform work in a divided manner. For example, a contractor (hereinafter, referred to as a contractor A) may be in charge of the work of bonding a plurality of construction members to the base member, and another contractor (hereinafter, referred to as a contractor B) may take over and be in charge of the work after the bonding is performed. Incidentally, it takes time to complete drying of the adhesive, that is, bonding of the plurality of construction members to the base member, and the time until completion differs for each construction member. Therefore, in a stage where the contractor B takes over the work, some of the plurality of construction members may not be completed. Here, in order to cause the worker of the contractor B to grasp which construction member among the plurality of construction members is completed and which construction member is not completed, it is necessary to perform detailed handover work between the contractor A and the contractor B. However, it is complicated to perform such handover work. Therefore, there is a demand for a technique capable of presenting the degree of completion of each of a plurality of construction members in a visually recognizable manner.

In order to meet the above demand, it is conceivable to use the technique described in Patent Literature 1. However, in the technique described in Patent Literature 1, since the mesh is not partitioned for each construction member, a plurality of construction members may be reflected in one area partitioned by the mesh. In this case, it is not possible to recognize which member of the plurality of construction members the color displayed in the area divided by the mesh indicates the degree of completion.

The present disclosure has been made in order to solve such a problem.

(1) An information processing method according to one aspect of the present disclosure is an information processing method in an information processing device, the method including: acquiring a first image obtained by capturing a plurality of bonding targets and an installation date and time of each of the plurality of bonding targets; recognizing the plurality of bonding targets included in the first image; acquiring a second image obtained by capturing the plurality of bonding targets after imaging of the first image and acquiring an imaging date and time when the imaging has been performed; calculating a scheduled completion date and time of each of the plurality of bonding targets based on the installation date and time; deciding, for each of the bonding targets, a position of the imaging date and time on a time axis from the installation date and time to the scheduled completion date and time, and deciding color information predetermined for the decided position; generating a superimposed image in which the color information is superimposed on each of the plurality of bonding targets included in the second image based on a recognition result of the first image; and outputting the superimposed image.

According to this configuration, a superimposed image in which different color information is superimposed for each bonding target can be presented to the worker. The color information changes according to the position of the imaging date and time on the time axis from the installation date and time to the scheduled completion date and time, that is, the remaining time until the bonding of the bonding target is completed. By presenting the superimposed image on which such color information is superimposed to the worker, the degree of completion of each of the plurality of bonding targets can be visually recognized.

(2) The information processing method according to (1) may further include: acquiring at least one of type information indicating a kind of each of the plurality of bonding targets, adhesive information related to an adhesive used for bonding of the plurality of bonding targets, and base member information related to a base member to which the plurality of bonding targets are bonded; and calculating the scheduled completion date and time based on at least one of the type information, the adhesive information, and the base member information.

According to this configuration, since at least one of the type information, the adhesive information, and the base member information is referred to in calculating the scheduled completion date and time, the scheduled completion date and time can be accurately calculated.

(3) The information processing method according to (1) or (2) may further include: acquiring weather information; and determining, based on the weather information, whether there is bad weather that affects completion of the plurality of bonding targets between the installation date and time and the imaging date and time, in which in the generating of the superimposed image, in a case where there is the bad weather, bad weather information indicating that there is the bad weather may be superimposed on the plurality of bonding targets included in the second image.

According to this configuration, it is possible to indicate to the worker that there has been bad weather between the installation date and time and the imaging date and time. Therefore, it is possible to notify the worker that there is a possibility that there is some influence on the completion of bonding of the bonding target due to bad weather.

(4) In the information processing method according to (3), in the calculating of the scheduled completion date and time, in a case where there is the bad weather, the scheduled completion date and time reflecting an influence of the bad weather may be calculated.

According to this configuration, the influence of bad weather can be reflected in the scheduled completion date and time.

(5) In the information processing method according to (3) or (4), in the calculating of the scheduled completion date and time, in a case where there is the bad weather, the scheduled completion date and time may be calculated by adding a time during which the bad weather has continued to the scheduled completion date and time calculated in a case where there is no bad weather.

According to this configuration, the scheduled completion date and time can be calculated simply by adding the time during which the bad weather continues to the scheduled completion date and time calculated in a case where there is no bad weather. Therefore, the processing load on the information processing device can be reduced as compared with a case where the scheduled completion date and time is calculated by executing complicated processing.

(6) In the information processing method according to any one of (3) to (5), the bad weather may be rain or snow, and in the calculating of the scheduled completion date and time, in a case where there is the bad weather, an end time of the bad weather may be set as the installation date and time.

According to this configuration, it is possible to calculate the scheduled completion date and time reflecting a situation in which, once the bonding target is wet due to rain, snow, or the like, the progress of bonding returns to the initial state in which the bonding target is installed.

(7) The information processing method according to any one of (3) to (6) may further include determining whether the bad weather has continued for a predetermined time or more in a case where there is the bad weather, in which in the generating of the superimposed image, in a case where the bad weather has continued for a predetermined time or more, recommended information for recommending confirmation of a state of each of the plurality of bonding targets may be superimposed on each of the plurality of bonding targets included in the second image.

According to this configuration, in a case where the bad weather continues for a predetermined time or more, it is possible to prompt the worker to confirm the states of the plurality of bonding targets. Therefore, if any abnormality occurs in the bonding target due to bad weather that continues for a predetermined time or more, it is suppressed that the abnormality is overlooked.

(8) In the information processing method according to any one of (3) to (7), in the generating of the superimposed image, in a case where the bad weather has continued for a predetermined time or more, at least one of the installation date and time, the scheduled completion date and time, the type information, the adhesive information, and the base member information may be superimposed on each of the plurality of bonding targets included in the second image.

According to this configuration, in a case where the bad weather continues for a predetermined time or more, at least one of the installation date and time, the scheduled completion date and time, the type information, the adhesive information, and the base member information is presented to the worker together with the recommended information. Therefore, more information can be presented to the worker.

(9) The information processing method according to any one of (3) to (8) may further include: acquiring arrangement information indicating arrangement of each bonding target at a work site where the plurality of bonding targets are bonded; and determining, for each of the bonding targets, whether the bonding target is arranged at a position affected by the bad weather at the work site based on the arrangement information.

According to this configuration, it is possible to distinguish the bonding target arranged at the position affected by the weather from the bonding target arranged at the position not affected by the weather. As a result, accurate color information can be superimposed on each of the plurality of bonding targets.

(10) The information processing method according to (1) or (2) may further include: acquiring weather information; and determining, based on the weather information, whether bad weather that affects completion of the plurality of bonding targets is predicted to come between the imaging date and time and the scheduled completion date and time, in which in the generating of the superimposed image, in a case where the bad weather is predicted to come, bad weather preparation information recommending preparation for the bad weather may be superimposed on each of the plurality of bonding targets included in the second image.

According to this configuration, in a case where the bad weather is predicted to come, it is possible to prompt the worker to prepare for the bad weather. Therefore, it is possible to suppress the influence of bad weather on the completion of bonding of the plurality of bonding targets.

(11) The information processing method according to (10) may further include: acquiring arrangement information indicating arrangement of each bonding target at a work site where the plurality of bonding targets are bonded; and determining, for each of the bonding targets, whether the bonding target is installed at a position affected by the bad weather at the work site based on the arrangement information.

According to this configuration, it is possible to distinguish the bonding target installed at the position affected by the weather from the bonding target installed at the position not affected by the weather. Therefore, the bonding target that needs to be prepared for bad weather can be clearly shown to the worker.

(12) The information processing method according to any one of (1) to (11) may further include: calculating a load-bearing capacity of each of the plurality of bonding targets based on the scheduled completion date and time, in which in the generating of the superimposed image, load-bearing information indicating the load-bearing capacity may be superimposed on each of the plurality of bonding targets included in the second image.

According to this configuration, the superimposed image in which the load-bearing information is superimposed on each of the plurality of bonding targets can be presented to the worker. Therefore, it is possible to indicate to the worker how heavy an object may be placed for each bonding target.

(13) The information processing method according to any one of (1) to (12) may further include: recognizing bonding targets installed at a common date and time among the plurality of bonding targets as a bonding target group, in which in the generating of the superimposed image, the second image may be superimposed with distinction information for emphasizing distinction between the bonding target group and another bonding target group of bonding targets installed at a common date and time different from that of the bonding target group.

According to this configuration, it is possible to present the superimposed image in which the bonding target group and the other bonding target group are clearly distinguished to the worker.

(14) The information processing method according to any one of (1) to (13) may further include: determining whether bonding of the bonding target is completed for each of the bonding targets, in which in the generating of the superimposed image, bonding completion information may be superimposed on a bonding target determined to have been completely bonded among the plurality of bonding targets included in the second image.

According to this configuration, it is possible to clearly indicate to the worker which bonding target among the plurality of bonding targets has been completely bonded and which bonding target has not been completely bonded.

(15) The information processing method according to (14) may further include: acquiring at least one of type information indicating a kind of each of the plurality of bonding targets, adhesive information related to an adhesive used for bonding of the plurality of bonding targets, and base member information related to a base member to which the plurality of bonding targets are bonded, in which in the generating of the superimposed image, at least one of the installation date and time, the scheduled completion date and time, the type information, the adhesive information, and the base member information may be superimposed on a bonding target determined to have been completely bonded among the plurality of bonding targets included in the second image.

According to this configuration, it is possible to present various pieces of information regarding the bonding target that has been completely bonded to the worker.

(16) In the information processing method according to any one of (1) to (15), in the generating of the superimposed image, the color information may be superimposed only on a bonding target that satisfies a condition input by a worker among the plurality of bonding targets included in the second image, and the color information may not be superimposed on other bonding targets.

According to this configuration, for example, it is possible to present, to the worker, a superimposed image in which color information is superimposed only on a bonding target desired to be intensively confirmed by the worker, and color information is not superimposed on the other bonding targets.

(17) An information processing device according to another aspect of the present disclosure includes: a first acquisition unit that acquires a first image obtained by capturing a plurality of bonding targets and an installation date and time of each of the plurality of bonding targets; a recognition unit that recognizes the plurality of bonding targets included in the first image; a second acquisition unit that acquires a second image obtained by capturing the plurality of bonding targets after imaging of the first image and acquires an imaging date and time when the imaging has been performed; a calculation unit that calculates a scheduled completion date and time of each of the plurality of bonding targets based on the installation date and time; a decision unit that decides, for each of the bonding targets, a position of the imaging date and time on a time axis from the installation date and time to the scheduled completion date and time, and decides color information predetermined for the decided position; a generation unit that generates a superimposed image in which the color information is superimposed on each of the plurality of bonding targets included in the second image based on a recognition result of the first image; and an output unit that outputs the superimposed image.

According to this configuration, it is possible to provide an information processing device that executes the information processing method.

(18) An information processing program according to another aspect of the present disclosure causes a computer to execute: acquiring a first image obtained by capturing a plurality of bonding targets and an installation date and time of each of the plurality of bonding targets; recognizing the plurality of bonding targets included in the first image; acquiring a second image obtained by capturing the plurality of bonding targets after imaging of the first image and acquiring an imaging date and time when the imaging has been performed; calculating a scheduled completion date and time of each of the plurality of bonding targets based on the installation date and time; deciding, for each of the bonding targets, a position of the imaging date and time on a time axis from the installation date and time to the scheduled completion date and time, and deciding color information predetermined for the decided position; generating a superimposed image in which the color information is superimposed on each of the plurality of bonding targets included in the second image based on a recognition result of the first image; and outputting the superimposed image.

According to this configuration, it is possible to provide an information processing program for executing the information processing method.

The present disclosure can be also implemented as an information processing system that is operated by such an information processing program. It is needless to say that such a computer program can be distributed via a computer-readable non-transitory recording medium such as a CD-ROM or via a communication network such as the Internet.

Note that each of embodiments to be described below illustrates a specific example of the present disclosure. Numerical values, shapes, constituent elements, steps, order of steps, and the like of the embodiment below are merely examples, and do not intend to limit the present disclosure. Further, a constituent element not described in an independent claim representing a highest concept among constituent elements in the embodiments below is described as an optional constituent element. Further, in all the embodiments, content of each of the embodiments can be combined.

### First Embodiment

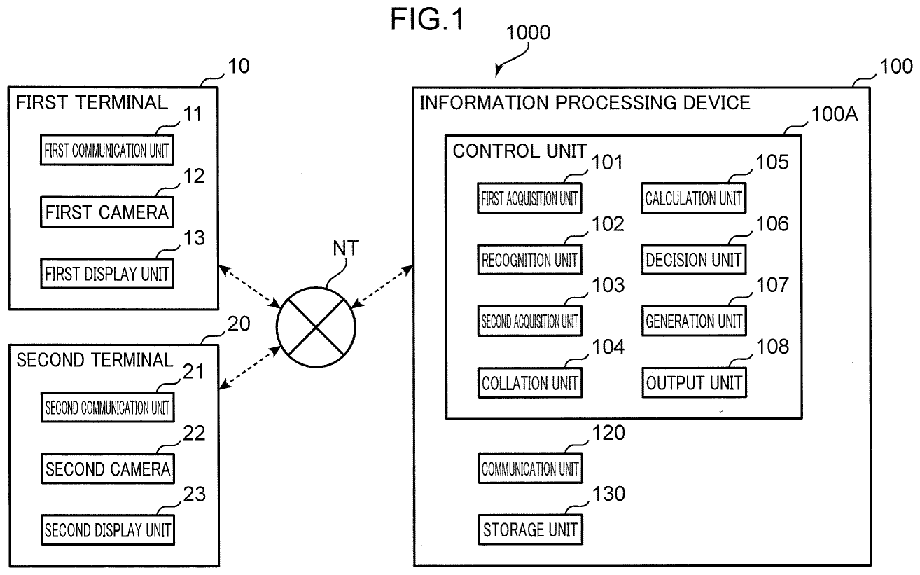

FIG. 1 is a block diagram illustrating an example of an overall configuration of an information processing system 1000 to which an information processing device 100 according to the first embodiment of the present disclosure. The information processing system 1000 according to the first embodiment relates to a vision-based augmented reality (AR) that superimposes various types of information such as characters, colors, and figures on an image obtained by capturing a predetermined object existing in the real world and displays the superimposed image on a predetermined display device. The information processing system 1000 includes a first terminal 10, a second terminal 20, and an information processing device 100. The first terminal 10, the second terminal 20, and the information processing device 100 are communicably connected to each other via a network NT. The network NT is, for example, a wide-area communication network including the Internet and a mobile phone communication network.

The first terminal 10 is a portable device such as a tablet computer and a smartphone. However, the first terminal 10 may be a camera device, AR glasses, or the like. The first terminal 10 is carried by a first worker who performs work of bonding a plurality of bonding targets to a base member B at a work site under construction. That is, the first terminal 10 is carried by a first worker who works at a work site where a plurality of bonding targets are bonded. In the following description, an example in which the first worker bonds a construction member E as the bonding target to the base member B will be described. However, the example of the bonding target is not limited to the construction member E, and can be appropriately changed.

The construction member E is a tile manufactured by, for example, clay. However, the construction member E is not limited to a tile, and may be, for example, a block. The material of the construction member E is not limited to clay, and may be, for example, stone, carbon fiber reinforced plastics (CFRP), metal, resin, glass, or the like.

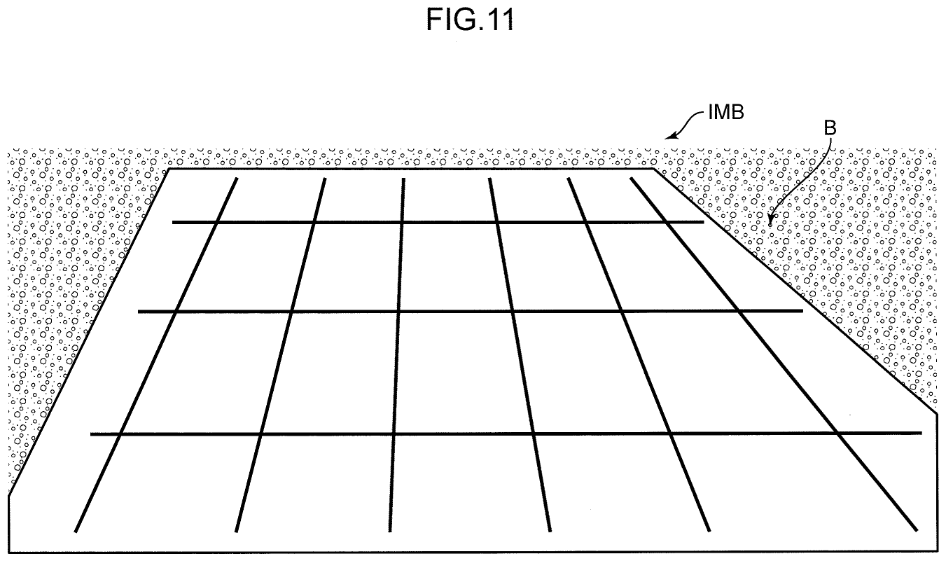

The base member B (see FIG. 11) is a base for installing the plurality of construction members E. The plurality of construction members E are installed on the base member B via an adhesive or the like. The base member B includes, for example, a mortar base and a reinforcing bar frame.

As illustrated in FIG. 1, the first terminal 10 includes a first communication unit 11, a first camera 12, and a first display unit 13.

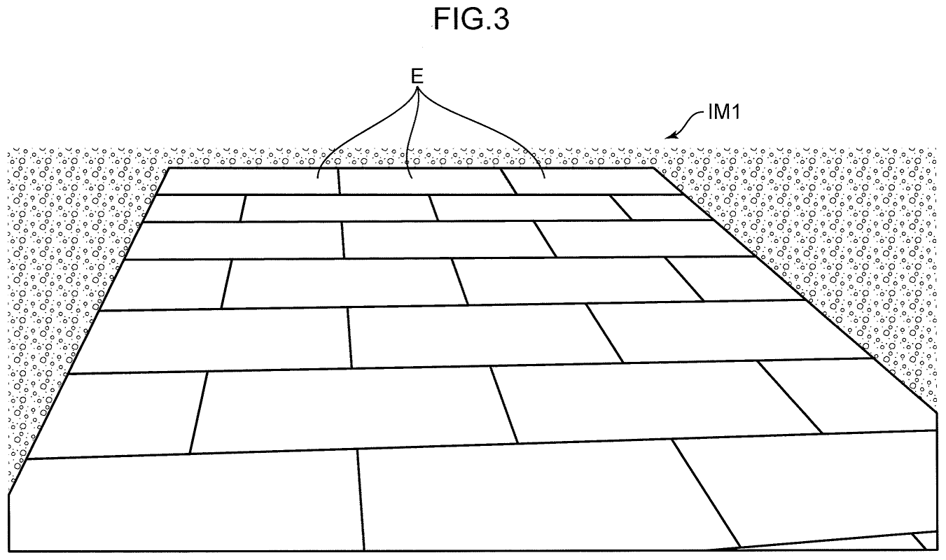

The first communication unit 11 is configured with a communication circuit that connects the first terminal 10 to the network NT. The first communication unit 11 transmits a first image IM1 (see FIG. 3) including a plurality of construction members bonded to the base member B to the information processing device 100 in response to an input from the first worker. The first image IM1 is generated when the first worker captures images of the plurality of construction members E with the first camera 12. In the present embodiment, the first image IM1 is captured when the work of the first worker (work of bonding the plurality of construction members E to the base member B) has ended. The first image IM1 is associated with a first imaging date and time related to the date and time when the first image IM1 is captured. The first imaging date and time is information including, for example, year, month, and day.

The first display unit 13 includes, for example, a display device such as a liquid crystal panel, and displays various information to the first worker. For example, the first display unit 13 can display a first input screen 13A for allowing the worker to input information on the plurality of construction members E. The first input screen 13A will be described later.

The second terminal 20 is a portable device such as a tablet computer and a smartphone. However, the second terminal 20 may be a camera device, AR glasses, or the like. The second terminal 20 is carried by a second worker who has taken over, from the first worker, the work site where work (work of bonding the plurality of construction members E to the base member B) has been performed by the first worker.

As illustrated in FIG. 1, the second terminal 20 includes a second communication unit 21, a second camera 22, and a second display unit 23.

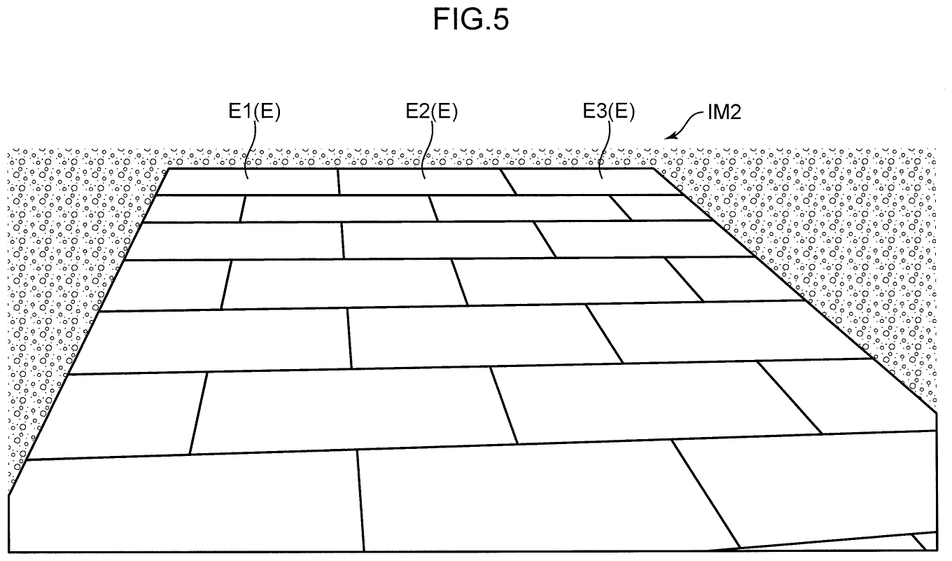

The second communication unit 21 is configured with a communication circuit that connects the second terminal 20 to the network NT. In response to the input from the second worker, the second communication unit 21 transmits, to the information processing device 100, a second image IM2 (see FIG. 5) including the plurality of construction members E after the first image IM1 is captured. The second image IM2 is generated by the second worker imaging the plurality of construction members E in the form of a still image or a moving image by the second camera 22 after the first image IM1 is captured. The second image IM2 according to the present embodiment is captured, for example, 18 hours after the first image IM1 is captured. However, the timing of capturing the second image IM2 is not limited thereto, and can be changed as appropriate.

The second image IM2 according to the present embodiment is associated with a second imaging date and time (imaging date and time) related to the date and time when the second image IM2 is captured. The second imaging date and time is information including, for example, year, month, and day.

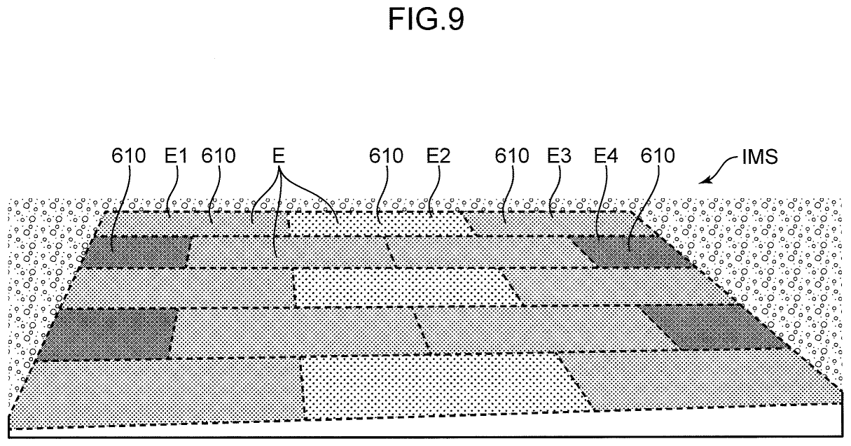

The second display unit 23 includes, for example, a display device such as a liquid crystal panel, and displays various information to the second worker. For example, the second display unit 23 displays a superimposed image IMS generated by superimposing various types of information including color information 610 on the second image IM2. The color information 610 and the superimposed image IMS will be described later with reference to FIG. 9.

The information processing device 100 is, for example, a cloud server including computers. As illustrated in FIG. 1, the information processing device 100 includes a communication unit 120, a control unit 100A, and a storage unit 130.

The communication unit 120 is configured with a communication circuit that connects the information processing device 100 to the network NT.

The control unit 100A is, for example, a central processing unit (CPU). The control unit 100A includes a first acquisition unit 101, a recognition unit 102, a second acquisition unit 103, a collation unit 104, a calculation unit 105, a decision unit 106, a generation unit 107, and an output unit 108. The first acquisition unit 101 through the output unit 108 may be implemented by the control unit 100A executing an information processing program, or may be configured by a dedicated hardware circuit such as an application-specific integrated circuit (ASIC).

Note that each functional unit of the control unit 100A illustrated in FIG. 1 is an example, and some functional units may be further separated into a plurality of elements, or a plurality of functional units may be integrated as one element. Furthermore, a part of the processing executed by each functional unit may be executed by an external device (not illustrated) or the like communicably connected to the information processing device 100.

The first acquisition unit 101 acquires the first image IM1 and the installation date and time of each of the plurality of construction members E. The first image IM1 can be acquired from the first terminal 10 via the communication unit 120. As described above, the first imaging date and time is associated with the first image IM1. In the present embodiment, the first imaging date and time is regarded as the installation date and time.

The recognition unit 102 recognizes each of the plurality of construction members E included in the first image IM1 by performing predetermined image recognition processing on the first image IM1. For example, the recognition unit 102 recognizes each of the plurality of construction members E by executing image recognition processing of recognizing the plurality of construction members E captured in the first image IM1 and a joint portion formed between the plurality of construction members E.

In addition, the recognition unit 102 acquires type information indicating the kind of each of the plurality of construction members E by executing image recognition processing of discriminating the kind of each of the plurality of construction members E in addition to the above-described image recognition processing. The kind of each of the plurality of construction members E can be discriminated, for example, based on the feature amount of each of the plurality of construction members E acquired from the first image IM1 by an existing image recognition technique. An example of the feature amount is information indicating a form, a material, a color, and the like of the construction member E.

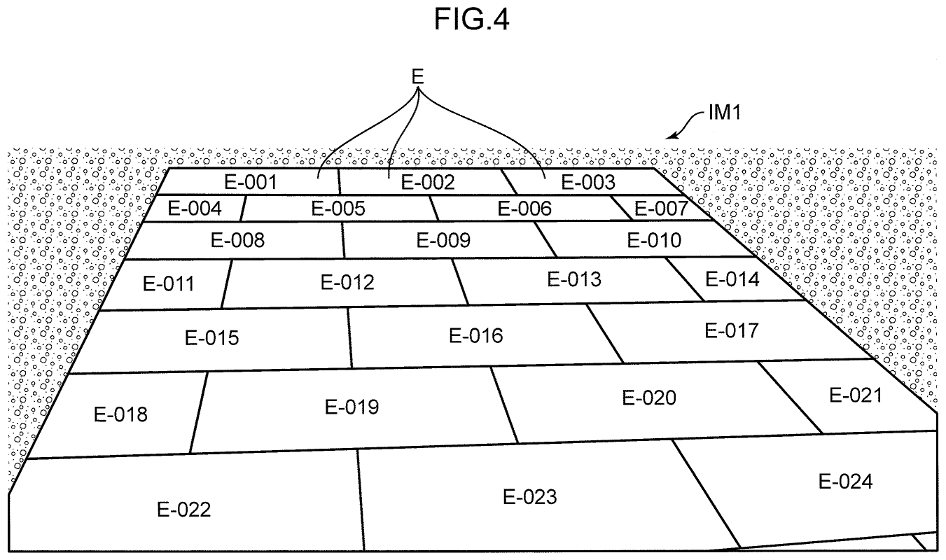

In addition, the recognition unit 102 assigns an ID for uniquely specifying each construction member E to each recognized construction member E. As illustrated in FIG. 4, in the present embodiment, IDs are assigned in the order of E-001, E-002, E-003, . . . according to a predetermined arrangement order. Then, the recognition unit 102 associates information of each construction member E with each ID. The information associated with each ID includes, for example, type information and installation date and time of each construction member E.

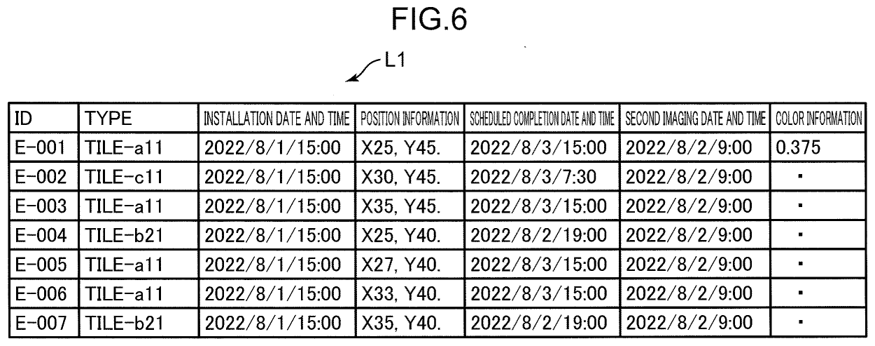

By the above-described processing of the recognition unit 102, a construction member list L1 as illustrated in FIG. 6 is generated. Each functional unit of the control unit 100A refers to the construction member list L1 to appropriately acquire information necessary for executing various types of processing. In addition, the information stored in the construction member list L1 is appropriately added according to the processing of each functional unit. The construction member list L1 includes columns of “ID”, “type”, “installation date and time”, “position information”, “scheduled completion date and time”, “second imaging date and time”, and “color information 610”.

In the column “ID”, an ID (identifier) of each construction member E is stored. In the column of “type”, type information of each construction member E is stored. In the column of “installation date and time”, the date and time when each construction member E is installed is stored. As described above, in the present embodiment, since the first imaging date and time is regarded as the installation date and time, the first imaging date and time is stored in the column of “installation date and time” in FIG. 6. The column “position information” will be described in the second embodiment. In the column of “scheduled completion date and time”, the scheduled completion date and time of each construction member E calculated by the calculation unit 105 is stored. In the column of “second imaging date and time”, the second imaging date and time acquired by the second acquisition unit 103 is stored. In the column of “color information 610”, the color information 610 of each construction member E decided by the decision unit 106 is stored.

The second acquisition unit 103 acquires the second image IM2 and the second imaging date and time from the second terminal 20 via the communication unit 120. As described above, the second imaging date and time is associated with the second image IM2.

The collation unit 104 recognizes a plurality of construction members E captured in the second image IM2 and collates the recognition results with the recognition results of the plurality of construction members E in the first image IM1. Specifically, the collation unit 104 recognizes each of the plurality of construction members E included in the second image IM2 by performing predetermined image recognition processing on the second image IM2. Then, the collation unit 104 calculates a matching rate between each construction member E (see FIG. 5) recognized in the second image IM2 and each construction member E (see FIG. 4) recognized in the first image IM1, and specifies a correspondence of each construction member E based on the matching rate. Note that the matching rate is a value indicating how much a certain construction member E matches another construction member E.

For example, the collation unit 104 may associate a certain construction member E included in the second image IM2 with a construction member E having the maximum matching rate among the construction members E included in the first image IM1. In the examples of FIGS. 4 and 5, the collation unit 104 associates a construction member E1, a construction member E2, and a construction member E3 included in the second image IM2 with a construction member E-001, a construction member E-002, and a construction member E-003 in the first image IM1. The collation unit 104 also associates the remaining construction members E included in the second image IM2 similarly to the construction members E1 to E3. In other words, for each of the plurality of construction members E included in the second image IM2, the collation unit 104 assigns the ID of the construction member E having the maximum matching rate among the construction members E included in the first image IM1. The correspondence of each construction member E specified by the collation unit 104 is stored in the storage unit 130 as correspondence information.

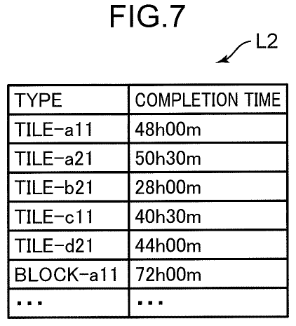

The calculation unit 105 calculates the scheduled completion date and time of each of the plurality of construction members E based on the installation date and time. Specifically, the calculation unit 105 calculates the scheduled completion date and time of each construction member E with reference to a completion time list L2 illustrated in FIG. 7. The completion time list L2 stores completion times corresponding to the types of the construction members E.

Hereinafter, the processing of the calculation unit 105 will be described by taking, as an example, a case of calculating the scheduled completion date and time of the construction member E (construction member E-001) to which the ID of E-001 is assigned in FIG. 4. In the example of FIG. 6, the type of the construction member E-001 is “TILE-a11”. In the example of FIG. 6, the installation date and time of the construction member E-001 is 15:00 on Aug. 1, 2022. As illustrated in FIG. 7, the completion time list L2 stores 48 hours as the completion time of the construction member E of “TILE-a11”. Therefore, the calculation unit 105 calculates 15:00 on Aug. 31, 2022 as the scheduled completion date and time of the construction member E-001 by adding the completion time “48 hours” to the installation date and time “15:00 on Aug. 15, 2022”. The completion time list L2 is stored in advance in the storage unit 130.

The decision unit 106 decides the position of the second imaging date and time on the time axis from the installation date and time to the scheduled completion date and time for each construction member E, and decides the color information 610 determined in advance for the decided position.

Specifically, the decision unit 106 refers to the installation date and time, the scheduled completion date and time, and the second imaging date and time of each construction member E. Then, the decision unit 106 decides, for each construction member E, a position corresponding to the second imaging date and time on the time axis in a case where the installation date and time is 0 and the scheduled completion date and time is 1.

Hereinafter, the processing of the decision unit 106 will be described by taking a case where the position of the construction member E-001 on the time axis is decided as an example. In the example of FIG. 6, the installation date and time of the construction member E-001 is 15:00 on Aug. 1, 2022, and the scheduled completion date and time is 15:00 on Aug. 3, 2022. In the example of FIG. 6, the second imaging date and time of the construction member E-001 is 9:00 on Aug. 2, 2022. Therefore, in a case where the installation date and time (15:00 on Aug. 1, 2022) of the construction member E-001 is 0 and the scheduled completion date and time (15:00 on Aug. 3, 2022) is 1, the second imaging date and time (9:00 on Aug. 2, 2022) corresponds to 0.375. From this, the decision unit 106 decides that the second imaging date and time of the construction member E-001 is located at 0.375 in the time axis from the installation date and time of the construction member E-001 to the scheduled completion date and time. Specifically, the decision unit 106 calculates the position on the time axis corresponding to the second imaging date and time by dividing the period from the installation date and time to the second imaging date and time by the period from the installation date and time to the scheduled completion date and time.

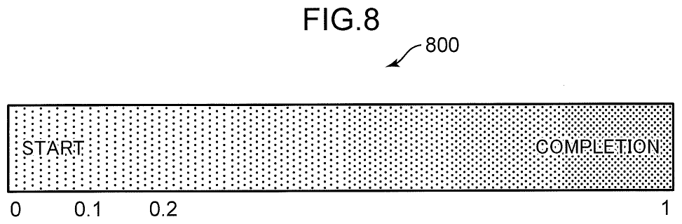

Here, the storage unit 130 stores color map information 800 as illustrated in FIG. 8. FIG. 8 is a schematic diagram of the color map information 800. In the horizontal axis of the color map information 800, a time axis from the installation date and time to the scheduled completion date and time is set. More specifically, the left end of the color map information 800 illustrated in FIG. 8 corresponds to the installation date and time, and the right end corresponds to the scheduled completion date and time. The color map information 800 defines a color corresponding to the position of the second imaging date and time on the time axis. For example, the color map information 800 defines purple for the position “0.1”, blue for the position “0.2”, light blue for the position “0.375”, and red for the position “1.0”. The decision unit 106 decides the color information 610 of the construction member E-001 to light blue based on the color map information 800. Note that the color information 610 is an example, and can be changed as appropriate. For example, the color map information 800 may define green for a position of 0.375. Furthermore, the color map information 800 may be substituted by grayscale map information (not illustrated) defining grayscale values of white and black according to the position on the time axis of the second imaging date and time. That is, the storage unit 130 may store grayscale map information defining information similar to the information defined in the color map information 800 by grayscale.

Further, the color map information 800 may be displayed on the second display unit 23 together with the superimposed image IMS.

The generation unit 107 generates the superimposed image IMS in which the color information 610 is superimposed on each of the plurality of construction members E included in the second image IM2 based on the recognition result of the first image IM1. Specifically, the generation unit 107 refers to the correspondence information generated by the collation unit 104 as the recognition result of the first image IM1, and grasps that, for example, the construction member E1 in the second image IM2 corresponds to the construction member E-001 in the first image IM1. As described above, since the color information 610 of the construction member E-001 is decided to be light blue, the generation unit 107 superimposes light blue on the construction member E-001 in the second image IM2. Various types of color information 610 are superimposed on each construction member E in the second image IM2 by a similar procedure, and the generation unit 107 generates the superimposed image IMS.

The output unit 108 outputs the superimposed image IMS to the second display unit 23 of the second terminal 20. Specifically, the output unit 108 transmits information necessary for causing the second display unit 23 to output (display) the superimposed image IMS to the second terminal 20. Examples of information necessary for outputting (displaying) the superimposed image IMS include image data of the superimposed image IMS and a program for displaying the superimposed image IMS on the second display unit 23.

The storage unit 130 includes a nonvolatile storage device. The storage unit 130 stores various types of information including the construction member list L1, the completion time list L2, and the color map information 800.

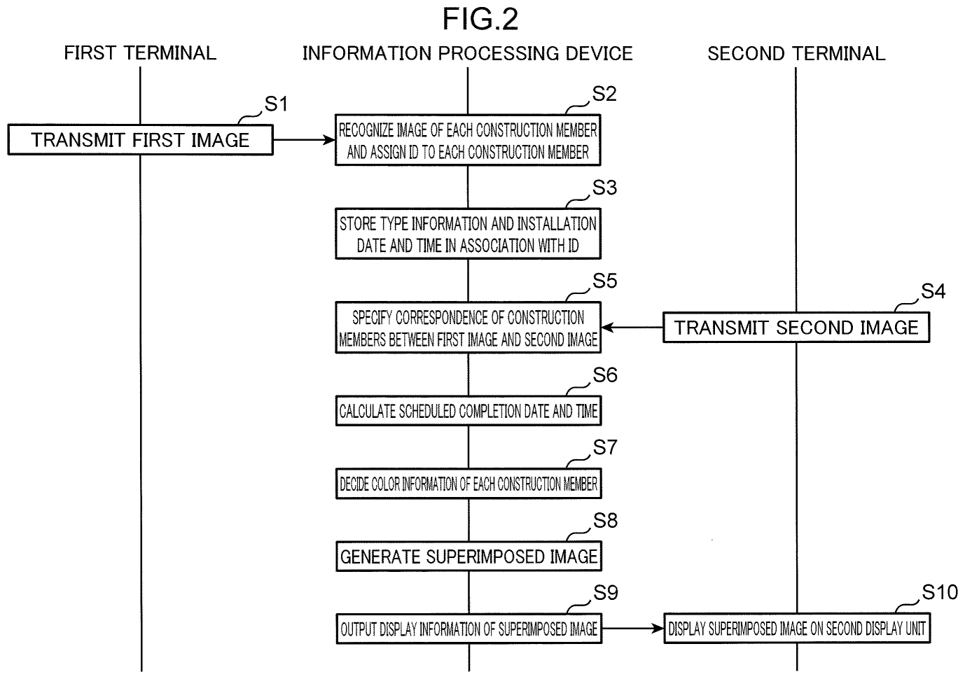

Next, an overall image of processing of the information processing system 1000 according to the present embodiment will be described. FIG. 2 is a sequence diagram illustrating an example of an overall image of processing of the information processing system 1000 in the present embodiment.

### Step S1

The first terminal 10 captures images of the plurality of construction members E by the first camera 12 to generate the first image IM1, and transmits the generated first image IM1 to the information processing device 100 via the first communication unit 11. The first imaging date and time is associated with the first image IM1. The first image IM1 is acquired by the first acquisition unit 101 of the information processing device 100.

### Step S2

The recognition unit 102 applies image recognition processing to the first image IM1, recognizes each construction member E in the first image IM1, and assigns an ID to each construction member E according to a predetermined arrangement order.

### Step S3

The recognition unit 102 associates the type information and the installation date and time (first imaging date and time) of each construction member E with the ID given to each construction member E.

### Step S4

The second terminal 20 captures images of the plurality of construction members E by the second camera 22 to acquire the second image IM2, and transmits the acquired second image IM2 to the information processing device 100 via the second communication unit 21. The second image IM2 is acquired by the second acquisition unit 103 of the information processing device 100.

### Step S5

The collation unit 104 recognizes a plurality of construction members E captured in the second image IM2, collates the recognition results with the recognition results of the plurality of construction members E in the first image IM1, and generates correspondence information specifying a correspondence between each construction member E in the first image IM1 and each construction member E in the second image IM2.

### Step S6

The calculation unit 105 calculates the scheduled completion date and time of each of the plurality of construction members E based on the installation date and time and the type information associated with the ID of each construction member E and the second imaging date and time.

### Step S7

The decision unit 106 decides the position of the second imaging date and time in the time axis from the installation date and time to the scheduled completion date and time for each construction member E based on the installation date and time, the scheduled completion date and time, and the second imaging date and time of each construction member E. In addition, the color information 610 for each construction member E is decided based on the position of each construction member E in the time axis and the color map information 800.

### Step S8

The generation unit 107 generates the superimposed image IMS in which the color information 610 for each construction member E is superimposed on each construction member E in the second image IM2.

FIG. 9 is a view illustrating an example of the superimposed image IMS. As illustrated in FIG. 9, in the superimposed image IMS, the color information 610 different for each construction member E is superimposed. In the example of FIG. 9, the color information 610 having a higher density is superimposed on a construction member E whose position of the second imaging date and time on the time axis from the installation date and time to the scheduled completion date and time is closer to the scheduled completion date and time. For example, the color information 610 superimposed on the construction member E1 is higher in density than the color information 610 superimposed on the construction member E2. For example, the color information 610 superimposed on a construction member E4 has a higher density than the color information 610 superimposed on the construction member E1. Therefore, the second worker can recognize that the construction member E1 is closer to the scheduled completion date and time than the construction member E2. In addition, the second worker can recognize that the construction member E4 is closer to the scheduled completion date and time than the construction member E1. In addition, the color information 610 having the same density is superimposed on the construction member E1 and the construction member E3. Therefore, the second worker can recognize that the construction member E1 and the construction member E3 have the same closeness to the scheduled completion date and time.

### Step S9

The output unit 108 transmits display information for causing the second display unit 23 to output the superimposed image IMS to the second terminal 20 via the communication unit 120.

### Step S10

The second display unit 23 displays the superimposed image IMS according to the received display information.

As described above, according to the first embodiment, the superimposed image IMS in which the color information 610 different for each construction member E is superimposed can be presented to the second worker. The color information 610 changes according to the position of the second imaging date and time on the time axis from the installation date and time to the scheduled completion date and time, that is, the remaining time until the bonding of the construction member E is completed. By presenting the superimposed image IMS on which the color information 610 is superimposed to the second worker, the degree of completion of each of the plurality of construction members E can be visually recognized.

### First Modification of First Embodiment

In the first embodiment, an example in which the information processing device 100 includes the control unit 100A has been described. Alternatively, however, the second terminal 20 may include the control unit 100A. That is, the processing in steps S2 and S3 and the processing in steps S5 to S9 in the sequence diagram of FIG. 2 may be mainly executed by the second terminal 20.

### Second Modification of First Embodiment

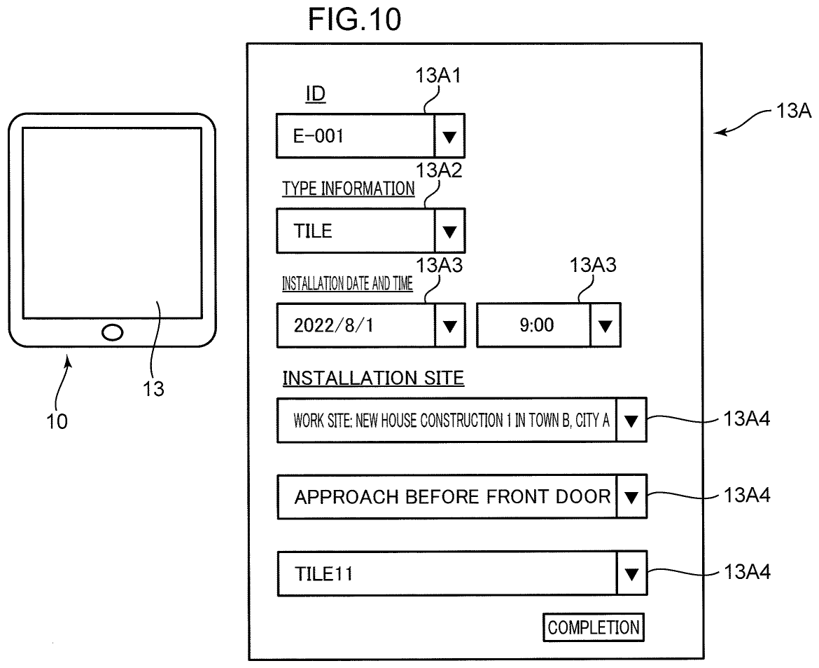

The first worker may input various types of information regarding the construction member E through the first input screen 13A (see FIG. 10) displayed on the first display unit 13 of the first terminal 10. As illustrated in FIG. 10, the first input screen 13A includes a first field 13A1 to a fourth field 13A4. The first field 13A1 is an input field of the ID of the construction member E. The second field 13A2 is an input field of type information of the construction member E. The third field 13A3 is an input field of the installation date and time of the construction member E. The fourth field 13A4 is an input field of the address of the work site and the outline of the arrangement place in the work site. Such input work may be executed at any timing within a period after completion of the image recognition processing on each construction member E by the recognition unit 102 and before acquisition of the second image IM2 by the second acquisition unit 103.

### Third Modification of First Embodiment

In the first embodiment, the calculation unit 105 calculates the scheduled completion date and time of the construction member E based on the type information of the construction member E and the installation date and time of the construction member E. However, the method of calculating the scheduled completion date and time by the calculation unit 105 is not limited thereto. For example, the calculation unit 105 may calculate the scheduled completion date and time of the construction member E based on the adhesive information regarding the adhesive used for bonding the plurality of construction members E to the base member B or the base member information regarding the base member B, and the installation date and time.

The adhesive information is information indicating the kind of adhesive and the like. For example, the first worker may input the adhesive information through the first input screen 13A. In this case, the first input screen 13A may include an input field of adhesive information.

The base member information includes a ground leveling situation of the ground on which the base member B is installed, an installation situation of a mortar base and a reinforcing bar frame, and mortar mix proportion information (information indicating a mix proportion of water, sand, and cement). The base member information can be acquired, for example, by image recognition of a base image IMB (see FIG. 11) obtained by capturing the base member B before the construction member E is installed. The base member information may be acquired by the first worker inputting the base member information through the first input screen 13A. In this case, the first input screen 13A may include an input field for base member information.

In addition, the completion time list L2 may store not only the completion time according to the type of the construction member E but also the completion time according to the adhesive information or the completion time according to the base member information.

Furthermore, the calculation unit 105 may calculate the scheduled completion date and time of the construction member E based on the type information, the adhesive information, the base member information, and the installation date and time. In this case, the completion time list L2 may store the completion time according to a combination of the type of the construction member E, the kind of the adhesive, and the base member information.

Based on these pieces of information, the calculation unit 105 can calculate a more accurate scheduled completion date and time.

### Fourth Modification of First Embodiment

The calculation unit 105 may calculate load-bearing information indicating the load-bearing capacity of each of the plurality of construction members E based on the scheduled completion date and time. For example, the calculation unit 105 may calculate the load-bearing capacity to be larger for the construction member E whose position on the time axis of the second imaging date and time is closer to the scheduled completion date and time, and calculate the load-bearing capacity to be smaller for the construction member E whose position on the time axis of the second imaging date and time is farther from the scheduled completion date and time. In addition, the generation unit 107 may generate the load-bearing information indicating the load-bearing capacity by reading the load-bearing information from the storage unit 130, and superimpose the load-bearing information on each construction member E in the second image IM2 together with the color information 610. Examples of the load-bearing information include a first cardboard box icon imitating a cardboard box which is empty, a second cardboard box icon imitating a cardboard box which is not empty and has a first size, a third cardboard box icon imitating a cardboard box which is not empty and has a second size larger than the first size, and an icon imitating a foot of a person. The generation unit 107 may generate the load-bearing information by reading these icons from the storage unit 130. Then, when generating the superimposed image IMS, the generation unit 107 may superimpose the first cardboard box icon on, for example, the construction member E on which a load cannot be placed. In addition, for example, the generation unit 107 may superimpose the second cardboard box icon on the construction member E on which a load of less than 15 kg can be placed. In addition, for example, the generation unit 107 may superimpose the third cardboard box icon on the construction member E on which a load of less than 30 kg can be placed. In addition, for example, the generation unit 107 may superimpose an icon imitating a foot of a person on the construction member E on which a person can be placed (on which a person may walk).

### Fifth Modification of First Embodiment

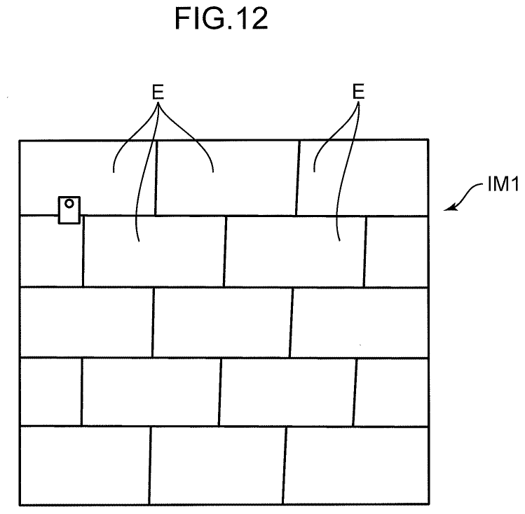

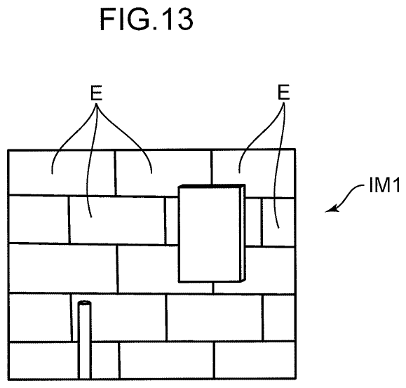

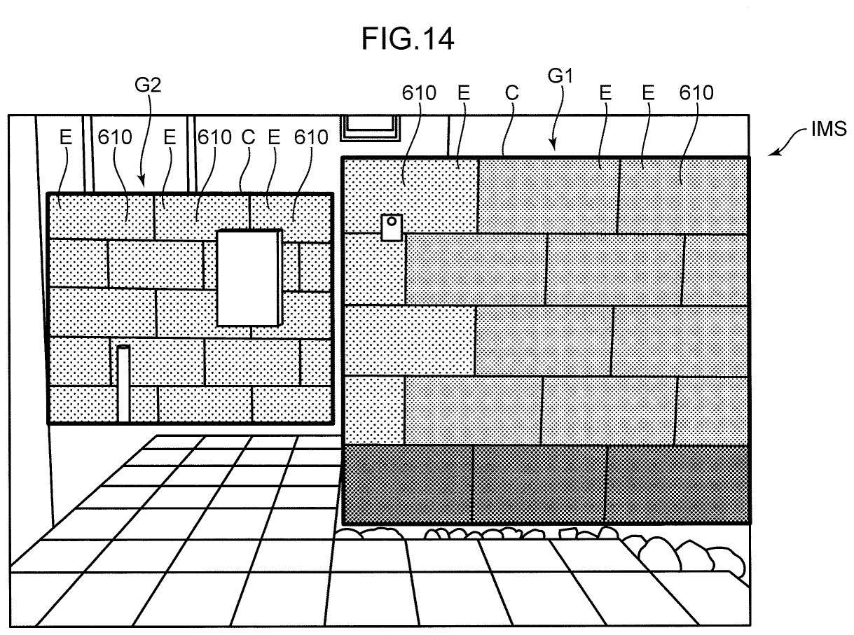

A plurality of contractors may install a plurality of construction members E on a daily basis at a common work site. For example, FIG. 12 is a view illustrating the first image IM1 obtained by capturing a plurality of construction members E installed by the worker of the contractor A. The first image IM1 is an image obtained by capturing a plurality of construction members E constituting a construction member group G1 illustrated in FIG. 14. FIG. 13 is a view illustrating the first image IM1 obtained by capturing a plurality of construction members E installed by the worker of the contractor B on the next day of installation by the worker of the contractor A. The first image IM1 is an image obtained by capturing a plurality of construction members E constituting a different construction member group G2 illustrated in FIG. 14.

In this case, the first acquisition unit 101 sequentially acquires the first image IM1 obtained by capturing the plurality of construction members E installed by the worker of the contractor A and the first image IM1 obtained by capturing the plurality of construction members E installed by the worker of the contractor B.

Thereafter, the second image IM2 in which the plurality of construction members E installed by the worker of the contractor A and the plurality of construction members E installed by the worker of the contractor B are contained in one view angle is captured and acquired by the second acquisition unit 103. FIG. 14 is a view illustrating the second image IM2 captured after the first image IM1 illustrated in FIG. 12 and the first image IM1 illustrated in FIG. 13.

In this case, when executing the processing of recognizing the plurality of construction members, the recognition unit 102 recognizes the construction members E installed at the common date and time among the plurality of construction members E as the construction member group G1 from the imaging date and time of the first image IM1 illustrated in FIG. 12. Similarly, the recognition unit 102 recognizes the construction members E installed at a common date and time different from that of the construction member group G1 from the imaging date and time of the first image IM1 illustrated in FIG. 13 as a different construction member group G2. Then, the generation unit 107 may superimpose distinction information C for emphasizing the distinction between the construction member group Gl and the different construction member group G2 recognized by the recognition unit 102 on the second image IM2 to generate the superimposed image IMS.

### Second Embodiment

An information processing device 200 according to a second embodiment generates a superimposed image IMS with reference to weather information 400. In the second embodiment, the same constituent elements as those in the first embodiment are denoted by the same reference numerals, and description thereof will be omitted.

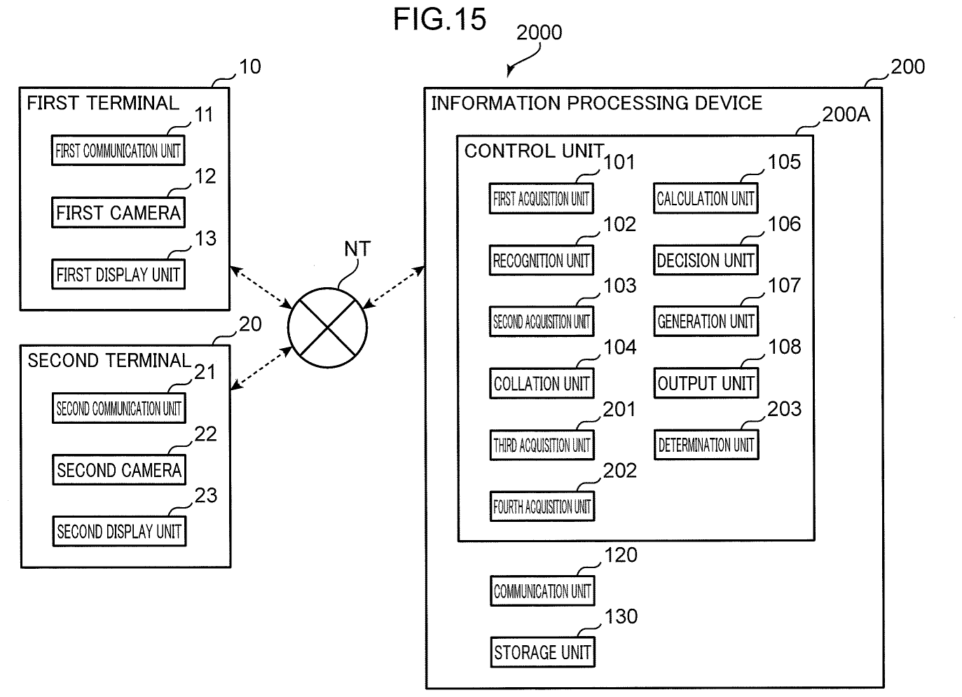

FIG. 15 is a view illustrating an example of an overall configuration of an information processing system 2000 in the second embodiment of the present disclosure. The information processing system 2000 according to the second embodiment includes an information processing device 200 having a control unit 200A. The control unit 200A is different from the control unit 100A according to the first embodiment in that the control unit 200A further includes a third acquisition unit 201, a fourth acquisition unit 202, and a determination unit 203.

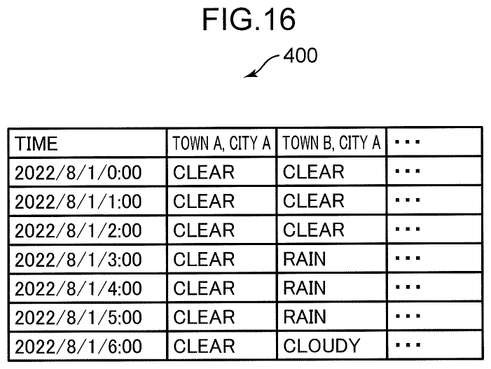

The third acquisition unit 201 acquires weather information regarding the weather at the work site. FIG. 16 is a view illustrating an example of a data configuration of the weather information 400 acquired by the third acquisition unit 201. The third acquisition unit 201 specifies the address of the work site based on the position information (GPS information) associated with the first image IM1 or the second image IM2. Then, the third acquisition unit 201 acquires the weather information 400 of the area including the specified address of the work site from, for example, an external device that provides weather information. The weather information 400 includes a temporal change of the weather in the area including the specified address. The weather information 400 indicates weather information 400 of a plurality of areas including “town B, city A” which is an area where the work site is located. The weather information 400 stores the contents of the weather from the present to the past certain period in time series every predetermined time (for example, 1 hour). The third acquisition unit 201 acquires the weather at the work site by specifying the content of the weather stored in the column of the area where the work site is located from the weather information 400.

The third acquisition unit 201 may acquire the address of the work site input by the first worker through the first input screen 13A, and acquire the weather information 400 using the acquired address of the work site.

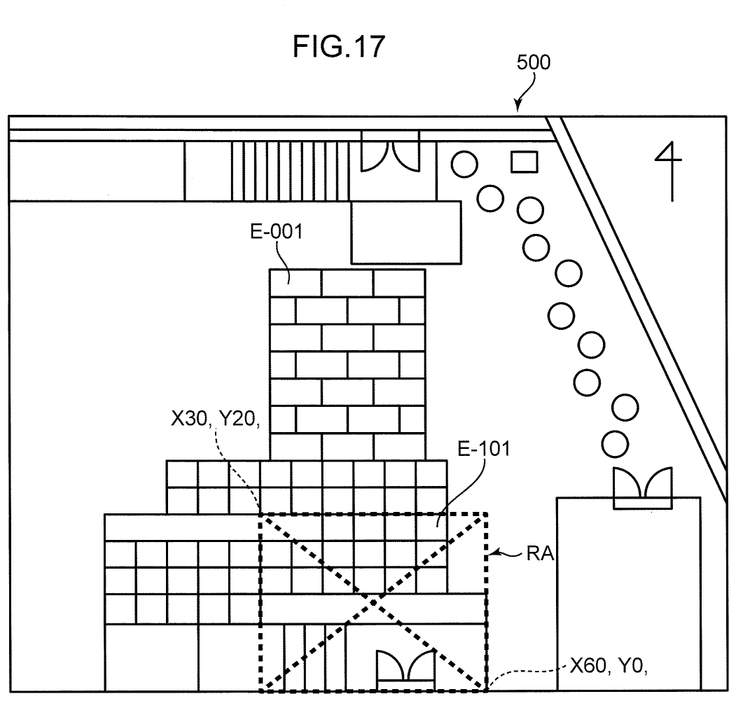

The fourth acquisition unit 202 acquires arrangement information indicating the arrangement of the plurality of construction members E captured in the second image IM2 at the work site. An example of the arrangement information is construction diagram information 500 illustrated in FIG. 17. FIG. 17 is a schematic diagram of the construction diagram information 500. The construction diagram information 500 is information obtained by mapping the arrangement of the plurality of construction members E arranged at the work site in a two-dimensional coordinate space having the X axis and the Y axis. As illustrated in FIG. 17, in the construction diagram information 500, the arrangement of each construction member E such as the construction member E-001 and the construction member E-101 at the work site is defined.

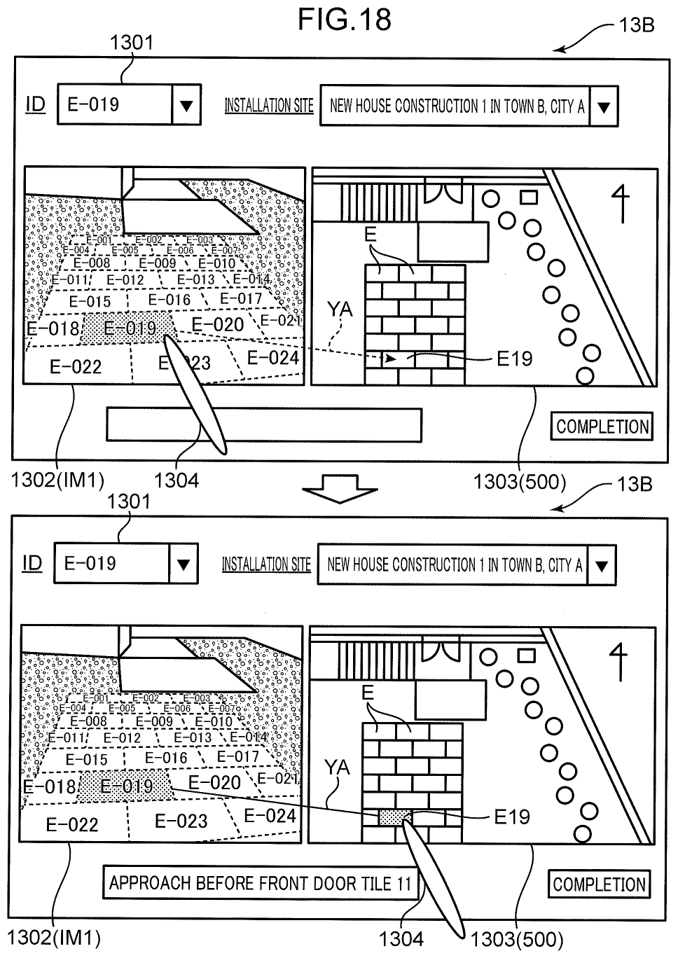

The construction diagram information 500 is generated by, for example, the first worker. FIG. 18 illustrates a second input screen 13B displayed on the first display unit 13 when the first worker generates the construction diagram information 500. The second input screen 13B in the upper part of FIG. 18 illustrates a second input screen 13B when the first worker selects the construction member E from the first image IM1. The second input screen 13B in the lower part of FIG. 18 illustrates a second input screen 13B when an association operation to be described later is input.

The upper part of FIG. 18 will be referred to. The second input screen 13B includes an ID display field 1301, a first image display field 1302, and a construction diagram information display field 1303.

The ID display field 1301 displays the ID of the construction member E selected by the first worker using a pointer 1304 in the first image IM1 displayed in the first image display field 1302. An example of the pointer 1304 is a finger of the first worker or a touch pen.

The first image display field 1302 displays the first image IM1. In the first image IM1 displayed in the first image display field 1302, an ID assigned to each construction member E is superimposed and displayed on each construction member E.

The construction diagram information display field 1303 displays the construction diagram information 500 illustrated in FIG. 17.

On the second input screen 13B in the upper part of FIG. 18, the first worker inputs an operation of selecting an arbitrary construction member E from among the construction members E. Here, an operation of selecting a construction member E-019 is input. Then, the first display unit 13 displays the area of the construction member E-019 displayed in the first image display field 1302 in a second color indicating that a default first color is selected. Furthermore, the first display unit 13 displays the ID of the selected construction member E-019 in the ID display field 1301.

Next, the first worker inputs an operation of associating the construction member E selected in the first image display field 1302 with any one of the construction members E displayed in the construction diagram information display field 1303 using the pointer 1304. For example, the first worker performs an operation of selecting and associating a construction member E19 corresponding to the construction member E-019 among the construction members E displayed in the construction diagram information display field 1303 using the pointer 1304. At this time, the first display unit 13 changes the default first color of the construction member E19 to the second color as illustrated in the lower part of FIG. 18. Alternatively, as indicated by an arrow YA, the first worker slides the pointer 1304 from the area of the construction member E-019 displayed in the first image display field 1302 to the area of the associated construction member E19 displayed in the construction diagram information display field 1303, thereby inputting an association operation.

The information input by the series of operations is transmitted from the first terminal 10 to the information processing device 100. The fourth acquisition unit 202 that has acquired this information associates the coordinates of the construction member E19 with the construction member E-019. Specifically, the fourth acquisition unit 202 stores the coordinates of the construction member E-019 in a column of position information of the construction member E-019 in the construction member list L1. The fourth acquisition unit 202 also performs such processing on other construction members E. As a result, the position information of each construction member E is stored in the construction member list L1.

In addition, in the construction diagram information 500 illustrated in FIG. 17, the coordinates of a roof area RA, which is an area where the roof is arranged, are also mapped. Specifically, the coordinates of an upper left (or upper right) vertex of the roof area RA and the coordinates of a lower right (or lower left) vertex are defined in the construction diagram information 500.

Based on the weather information 400, the determination unit 203 determines whether there is bad weather that affects the completion of the plurality of construction members E between the installation date and time and the second imaging date and time. The “bad weather” corresponds to, for example, a state where it is raining or snowing. However, the bad weather is not limited to a case where it is rainy or snowy, and a case where it is frost or hail, a case where the temperature or the solar radiation amount is less than a predetermined value, or a case where the humidity exceeds a predetermined value also corresponds to the bad weather.

Furthermore, the determination unit 203 determines, for each construction member E, whether the construction member E is arranged at a position affected by bad weather at the work site based on the arrangement information. Specifically, the determination unit 203 determines whether the construction member E is provided inside the roof area RA. For example, the construction member E-101 illustrated in FIG. 17 is provided inside the roof area RA. Therefore, in a case where it is raining, the determination unit 203 determines that the construction member E-101 whose upper side is covered by the roof is not affected by rain. On the other hand, the construction member E-001 illustrated in FIG. 17 is not provided inside the roof area RA. Therefore, in a case where it is raining, the determination unit 203 determines that the construction member E-001 is affected by rain. In addition, the determination unit 203 may determine that the construction member E is not affected by bad weather, for example, in a case where the construction member E is installed underground or in a case where an adhesive having a high waterproof property is used.

Next, processing of each functional unit for each construction member E determined to be installed at a position affected by bad weather in a case where it is determined that there is bad weather will be described.

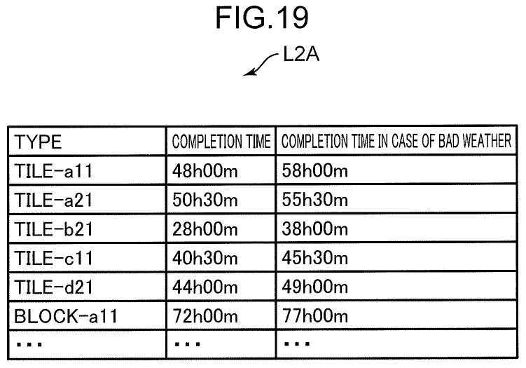

The calculation unit 105 calculates a scheduled completion date and time reflecting bad weather. Specifically, the calculation unit 105 calculates the scheduled completion date and time with reference to a completion time list L2A illustrated in FIG. 19. In the completion time list L2A, in addition to the completion time according to the type of the construction member E, the completion time according to the type of the construction member E in a case where there is bad weather is stored.

For example, in the first row of the completion time list L2A, the completion time of the type “TILE-a11” is “48 hours”, whereas the completion time in case of bad weather is “58 hours”. In this manner, in the completion time list L2A, the completion time in case of bad weather is set to be longer than the completion time in the case of no bad weather. Based on such information, the calculation unit 105 can calculate the scheduled completion date and time of each construction member E installed at a position affected by bad weather.

The processing of the calculation unit 105 will be specifically described with reference to FIG. 17. The construction member E-101 is arranged in the roof area RA. In this case, the determination unit 203 determines that the construction member E-101 is not affected by bad weather. Here, it is assumed that the type of the construction member E-101 is “TILE-a11”. In this case, the calculation unit 105 refers to the first row of the completion time list L2A illustrated in FIG. 19, and acquires “48 hours” which is the completion time in case of bad weather. Then, the calculation unit 105 calculates a date and time obtained by adding “48 hours” to the installation date and time of the construction member E-101 as the scheduled completion date and time.

On the other hand, the construction member E-001 is not installed inside the roof area RA. In this case, the determination unit 203 determines that the construction member E-001 is affected by bad weather. Here, it is assumed that the type of the construction member E-001 is “TILE-a11”. In this case, the calculation unit 105 refers to the first row of the completion time list L2A and acquires “58 hours” which is the completion time. Then, the calculation unit 105 calculates a date and time obtained by adding “58 hours” to the installation date and time of the construction member E-001 as the scheduled completion date and time.

The generation unit 107 superimposes bad weather information 620 indicating that bad weather has been present on each of the plurality of construction members E included in the second image IM2. Specifically, the generation unit 107 generates the bad weather information 620 for the construction member E determined to be affected by bad weather by the determination unit 203. Then, the generation unit 107 generates the superimposed image IMS in which the generated bad weather information 620 is superimposed on the corresponding construction member E together with the color information 610. An example of the bad weather information 620 is an icon indicating bad weather. This icon is stored in advance in the storage unit 130 of the information processing device 200, for example.

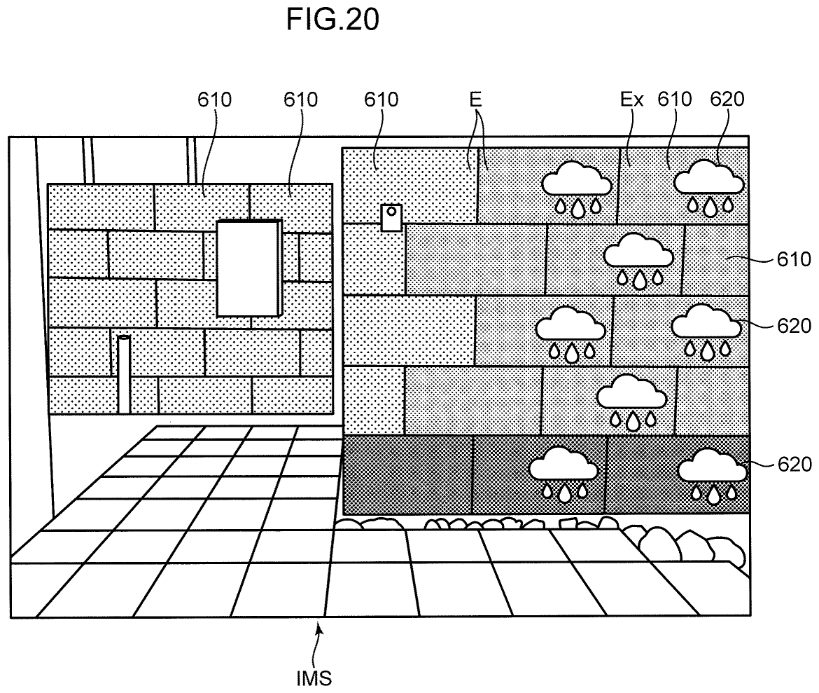

FIG. 20 is a view illustrating a superimposed image IMS on which the bad weather information 620 is superimposed. For example, a construction member Ex is the construction member E determined by the determination unit 203 to be affected by bad weather. Therefore, the generation unit 107 generates the bad weather information 620 by reading the icon indicating bad weather from the storage unit 130, and superimposes the generated bad weather information 620 on the construction member Ex together with the color information 610. As a result, the superimposed image IMS in which an icon indicating bad weather is superimposed and displayed on the construction member Ex in addition to the color information 610 is generated. On the other hand, an icon indicating bad weather is not superimposed on the construction member E determined not to be affected by bad weather by the determination unit 203. As a result, the second worker who has referred to the superimposed image IMS can easily confirm which construction member is the construction member E affected by bad weather. An example of the icon indicating bad weather is an image that symbolically indicates how it rains.

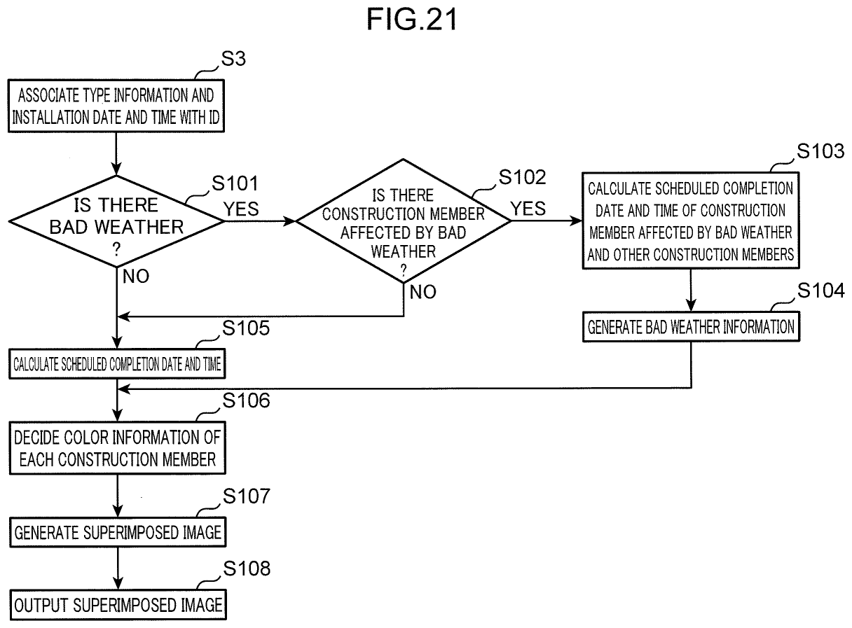

FIG. 21 is a flowchart illustrating an example of processing in the second embodiment. The flowchart of FIG. 21 illustrates processing after step S3 of the sequence diagram of FIG. 2.

### Step S101

Based on the weather information 400, the determination unit 203 determines whether there is bad weather that affects the completion of the plurality of construction members E between the installation date and time and the second imaging date and time. In a case where there is bad weather (YES in step S101), the processing of the information processing device 200 proceeds to step S102. In a case where there is no bad weather (NO in step S101), the processing of the information processing device 200 proceeds to step S105. For example, the determination unit 203 refers to the weather information 400 illustrated in FIG. 16, and determines whether each of the construction members E installed on the work site has been raining at least once in the period from the installation date and time to the second photographing date and time. Then, in a case where there is at least one construction member E that has been rained at least once, the determination unit 203 determines YES in step S102. On the other hand, in a case where there is no construction member E indicating that it has rained at least once, the determination unit 203 determines NO in step S102.

### Step S102

Based on the arrangement information, the determination unit 203 determines whether the construction member E arranged at a position affected by bad weather is present at the work site. In a case where there is the construction member E arranged at a position affected by bad weather (YES in step S102), the processing of the information processing device 200 proceeds to step S103. In a case where there is no construction member E arranged at a position affected by bad weather (NO in step S102), the processing of the information processing device 200 proceeds to step S105. For example, it is assumed that the arrangement information is construction diagram information 500 illustrated in FIG. 17. Since there is a construction member E (for example, the construction member E-001) not arranged under the roof area RA in the construction diagram information 500, YES is determined in step S102.

### Step S103

The calculation unit 105 calculates the scheduled completion date and time of each construction member E affected by bad weather and the scheduled completion date and time of each construction member E not affected by bad weather. In the construction diagram information 500 illustrated in FIG. 17, the construction member E-001 is a construction member E affected by bad weather. In this case, the calculation unit 105 specifies “completion time in case of bad weather” corresponding to the type of the construction member E-001 from the completion time list L2A. Then, the calculation unit 105 calculates the scheduled completion date and time of the construction member E-001 by adding the specified “completion time in case of bad weather” to the installation date and time of the construction member E-001. On the other hand, the construction member E-101 is a construction member E that is not affected by bad weather. In this case, the calculation unit 105 specifies “completion time” corresponding to the type of the construction member E-001 from the completion time list L2A. Then, the calculation unit 105 adds the specified completion time to the installation date and time of the construction member E-101 to calculate the scheduled completion date and time of the construction member E-101.

### Step S104

The generation unit 107 generates the bad weather information 620 to be superimposed on each construction member E affected by bad weather. The construction member E-001 illustrated in FIG. 17 is a construction member E affected by bad weather. Therefore, the generation unit 107 generates the bad weather information 620 by reading the icon indicating the bad weather from the storage unit 130 for the construction member E-001.

Since the processing executed in steps S105 and S106 is similar to the processing executed in steps S6 and S7 in FIG. 2, the description thereof will be omitted.

### Step S107

The generation unit 107 generates the superimposed image IMS in which the color information 610 is superimposed on each construction member E in the second image IM2 based on the color information 610 of each construction member E. At this time, the generation unit 107 superimposes the bad weather information 620 on each construction member E affected by bad weather together with the color information 610. As a result, the superimposed image IMS illustrated in FIG. 20 is generated. In the example of FIG. 20, the bad weather information 620 is superimposed on the color information 610 so that the bad weather information 620 is not hidden by the color information 610.

Since the processing executed in step S108 is similar to the processing executed in step S9 in FIG. 2, the description thereof will be omitted.

As described above, according to the second embodiment, the superimposed image IMS reflecting the influence of bad weather can be generated.

### First Modification of Second Embodiment

The scheduled completion date and time may be calculated by adding a time during which bad weather continues to the scheduled completion date and time calculated in a case where there is no bad weather (hereinafter, referred to as a normal scheduled completion date and time). Hereinafter, the construction member E-001 will be described as an example. As described in the first embodiment, the normal scheduled completion date and time of the construction member E-001 is 15:00 on Aug. 3, 2022. Here, it is assumed that the weather information 400 illustrated in FIG. 16 describes 3 hours as a time when it has rained at the installation site of the construction member E-001 between the installation date and time of the construction member E-001 and the second imaging date and time. In this case, the calculation unit 105 calculates the time obtained by adding 3 hours to the normal scheduled completion date and time, that is, 18:00 on Aug. 3, 2022 as the scheduled completion date and time. Note that, in a case where there is a plurality of times during which bad weather has continued between the installation date and time and the second imaging date and time, a total value of the times during which bad weather has continued may be added to the normal scheduled completion date and time.

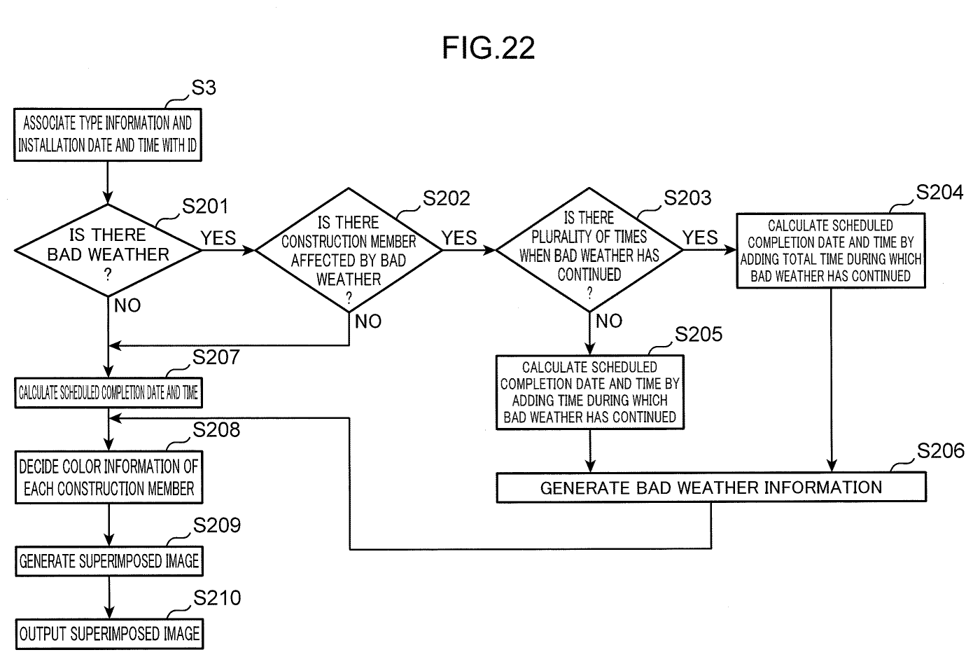

FIG. 22 is a flowchart illustrating an example of processing according to a first modification of the second embodiment. The flowchart of FIG. 22 illustrates processing after step S3 of the sequence diagram of FIG. 2.

Since the processing executed in steps S201 and S202 is similar to the processing executed in steps S101 and S102 in FIG. 21, the description thereof will be omitted.

### Step S203

Based on the weather information 400, the determination unit 203 determines whether there is a plurality of times during which bad weather has continued. In a case where there is a plurality of times during which bad weather has continued (YES in step S203), the processing of the information processing device 200 proceeds to step S204. In a case where there is no plurality of times during which bad weather has continued (NO in step S203), the processing of the information processing device 200 proceeds to step S205.

### Step S204

The calculation unit 105 calculates the scheduled completion date and time by adding the total time during which bad weather has continued to the normal scheduled completion date and time.

### Step S205

The calculation unit 105 calculates the scheduled completion date and time by adding the time during which bad weather has continued to the normal scheduled completion date and time.

Since the processing executed in steps S206 to S210 is similar to the processing executed in steps S104 to S108 in FIG. 21, the description thereof will be omitted.

### Second Modification of Second Embodiment

In a case where the determination unit 203 determines that there is bad weather because it is raining or snowing between the installation date and time and the second imaging date and time, the calculation unit 105 may reset the date and time when bad weather ended as the installation date and time, and calculate the scheduled completion date and time on the basis of the reset installation date and time. This is based on the idea that, in a case where it is raining or snowing, the construction member E and the adhesive are wet due to rain or snow, and the progress of drying of the adhesive is considered to be returning back. Therefore, the calculation unit 105 recalculates the scheduled completion date and time assuming that the drying of the adhesive has resumed from the time when the rain or snow ended.

Hereinafter, the construction member E-001 will be described as an example. As described in the first embodiment, the initial installation date and time of the construction member E-001 is 15:00 on Aug. 1, 2022, the normally scheduled completion date and time is 15:00 on Aug. 3, 2022, and the second imaging date and time is 9:00 on Aug. 2, 2022. Here, it is assumed that it has rained once between the installation date and time and the second imaging date and time. For example, it is assumed that it has rained between 14:00 on Aug. 2, 2022 and 15:00 on Aug. 2, 2022. In this case, the calculation unit 105 resets 15:00 on Aug. 2, 2022, which is the time when the rain has stopped, as the installation date and time of the construction member E-001. Here, as described in the first embodiment, since it takes 48 hours to complete the bonding of the construction member E-001, the calculation unit 105 calculates 15:00 on Aug. 4, 2022 as the scheduled completion date and time.

In a case where there is a plurality of times of bad weather between the installation date and time and the second imaging date and time, the time when the last (latest) bad weather ended may be reset as the installation date and time, and the scheduled completion date and time may be calculated on the basis of the reset installation date and time.

In addition, in a case where there is bad weather at the second imaging date and time, that is, in a case where it is raining at the timing of imaging the second image IM2, the decision unit 106 may decide that the second imaging date and time is located at the point of 0 on the time axis of the color map information 800. In this case, the decision unit 106 does not calculate the scheduled completion date and time.

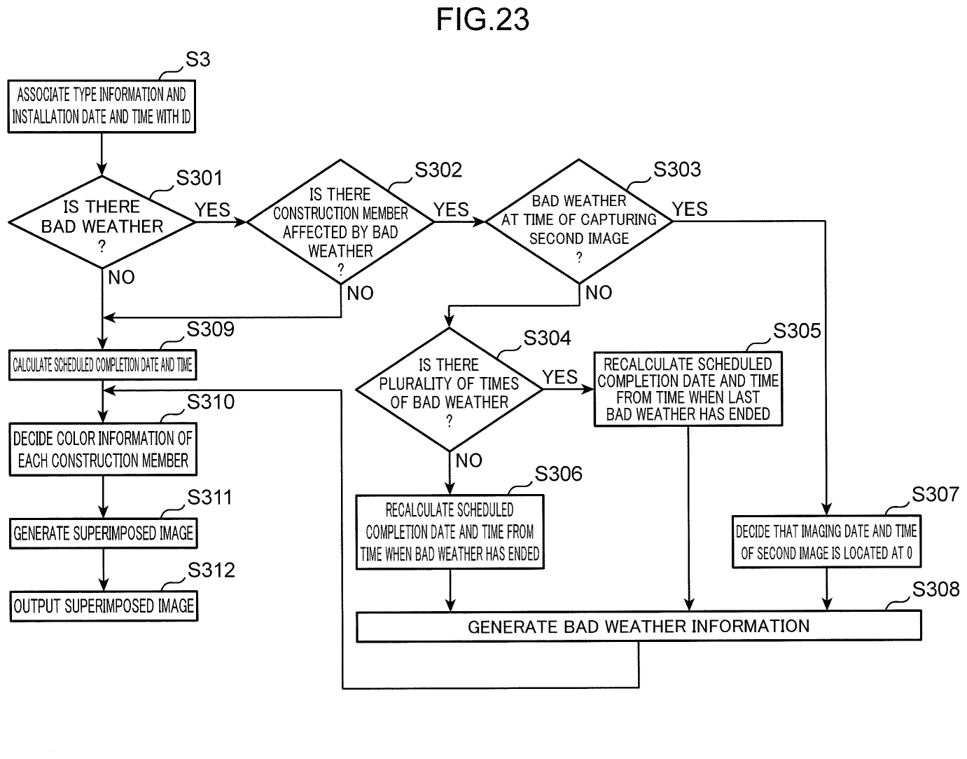

FIG. 23 is a flowchart illustrating an example of processing according to a second modification of the second embodiment. The flowchart of FIG. 23 illustrates processing after step S3 of the sequence diagram of FIG. 2.

Since the processing executed in steps S301 and S302 is similar to the processing executed in steps S101 and S102 in FIG. 21, the description thereof will be omitted.

### Step S303

The determination unit 203 refers to the weather information 400 and determines whether the weather at the second imaging date and time is bad weather. That is, the determination unit 203 determines whether it is raining at the timing of capturing the second image IM2. In a case where the weather at the second imaging date and time is bad weather (YES in step S303), the processing of the information processing device 200 proceeds to step S307. In a case where the weather at the second imaging date and time is not bad weather (NO in step S303), the processing of the information processing device 200 proceeds to step S304.

### Step S304

The determination unit 203 refers to the weather information 400 and determines whether a plurality of times of bad weather exists between the installation date and time and the second imaging date and time. In a case where there is a plurality of times of bad weather (YES in step S304), the processing of the information processing device 200 proceeds to step S305. In a case where there is no plurality of times of bad weather (NO in step S304), the processing of the information processing device 200 proceeds to step S306.

### Step S305

For each construction member E arranged at a position affected by bad weather, the calculation unit 105 resets the time when the last bad weather among the plurality of times of bad weather has ended as the installation date and time, and recalculates the scheduled completion date and time on the basis of the reset installation date and time. For example, in a case where it is described in the weather information 400 that there are two times of bad weather between the installation date and time and the second imaging date and time, the calculation unit 105 resets the time when the second bad weather has ended as the installation date and time, and recalculates the scheduled completion date and time of each construction member E on the basis of the reset installation date and time.

### Step S306

The calculation unit 105 resets the time when bad weather has ended as the installation date and time for each construction member E arranged at a position affected by bad weather, and recalculates the scheduled completion date and time on the basis of the reset installation date and time.

### Step S307

The decision unit 106 decides the position of the second imaging date and time on the time axis from the installation date and time to the scheduled completion date and time as 0 for each construction member E arranged at a position affected by bad weather.

Note that, in a case where the time at which falling rain or the like stops at the timing when the second image IM2 is captured can be specified based on a weather forecast or the like, the time may be reset as the installation date and time, and the scheduled completion date and time may be recalculated on the basis of the reset installation date and time.

Since the processing executed in steps S308 to S312 is similar to the processing executed in steps S104 to S108 in FIG. 21, the description thereof will be omitted.

### Third Modification of Second Embodiment

The weather information 400 acquired by the third acquisition unit 201 may include a weather forecast regarding the weather at the work site. For example, a weather forecast regarding the weather in a period between the second imaging date and time and the scheduled completion date and time may be included. In this case, the determination unit 203 may determine whether the weather forecast predicts that bad weather is predicted to come between the second imaging date and time and the scheduled completion date and time. Then, in a case where bad weather is predicted to come, the generation unit 107 may generate bad weather preparation information (not illustrated) for recommending preparation for the bad weather. For example, the generation unit 107 may read an icon imitating the curing tape from the storage unit 130 to generate the bad weather preparation information.

Further, the generation unit 107 may generate the superimposed image IMS by superimposing the bad weather preparation information on each construction member E in the second image IM2 together with the color information 610. In addition, the above-described bad weather preparation information may be superimposed only on the construction member E determined by the determination unit 203 to be arranged at a position affected by bad weather. That is, in a case where the weather forecast predicts that bad weather will arrive at the work site, the generation unit 107 may generate the superimposed image IMS in which an icon imitating a curing tape is superimposed on each construction member E arranged at a position affected by bad weather together with the color information 610. On the other hand, the generation unit 107 may generate the superimposed image IMS in which only the color information 610 is superimposed on each construction member E arranged at a position not affected by bad weather and an icon imitating the curing tape is not superimposed.

### Fourth Modification of Second Embodiment

In addition to the above determination, the determination unit 203 may determine, for each construction member E, whether bonding to the base member B has been completed. Then, in a case where there is the construction member E to which bonding to the base member B is completed, the generation unit 107 may generate bonding completion information for indicating that bonding is completed. Then, the generation unit 107 may generate the superimposed image IMS in which the bonding completion information is superimposed on the construction member E determined to have completed bonded among the plurality of construction members E.

Specifically, the determination unit 203 according to the present modification determines whether there is a construction member E whose position of the second imaging date and time on the time axis exceeds 1. Then, in a case where such a construction member E is present, the generation unit 107 generates the bonding completion information and superimposes the bonding completion information on the construction member E. The bonding completion information is, for example, a white texture. According to this configuration, the construction member E that has been completely bonded is displayed in white, and the superimposed image IMS in which various types of color information 610 are superimposed on the construction member E that has not been completely bonded is presented to the second worker. Alternatively, the generation unit 107 may generate the superimposed image IMS in which the color information 610 is not superimposed on the construction member E that has been completely bonded.

Note that there is a possibility that the weather information 400 acquired by the third acquisition unit 201 is slightly different from the actual weather at the work site. Therefore, there is a possibility that the bonding of the construction member E is not completed at the scheduled completion date and time calculated by the calculation unit 105. As a result, the determination unit 203 may determine that the bonding is completed although the bonding is not actually completed. In order to solve such a problem, instead of the above determination, the determination unit 203 may determine that bonding is completed only in a case where a predetermined time has elapsed after the position of the second imaging date and time on the time axis exceeds 1.

In addition, at least one of the installation date and time, the scheduled completion date and time, the type information, the adhesive information, and the base member information may be superimposed on the construction member E determined to have been completely bonded among the plurality of construction members E included in the second image IM2.

### Third Embodiment

In a case where the time during which it is raining continues for a predetermined time or more, a white product called powdering or scum may float on the surface of the construction member E due to a white flower phenomenon (efflorescence). In addition, for example, in a case where the air temperature of 30 degrees or more continues for a predetermined time or more, or in a case where the air temperature of 0 degrees or less continues for a predetermined time or more, there is a possibility that a cracking occurs on the surface of the construction member E. In this way, in a case where bad weather continues for a predetermined time or more, there is a possibility that some kind of abnormality occurs in the construction member E. An information processing device 300 according to the third embodiment prompts the second worker to confirm the state of the construction member E in a case where bad weather continues for a predetermined time or more. In the third embodiment, the same constituent elements as those in the first and second embodiments are denoted by the same reference numerals, and description thereof will be omitted. The overall configuration of the third embodiment will be described with reference to FIG. 15.

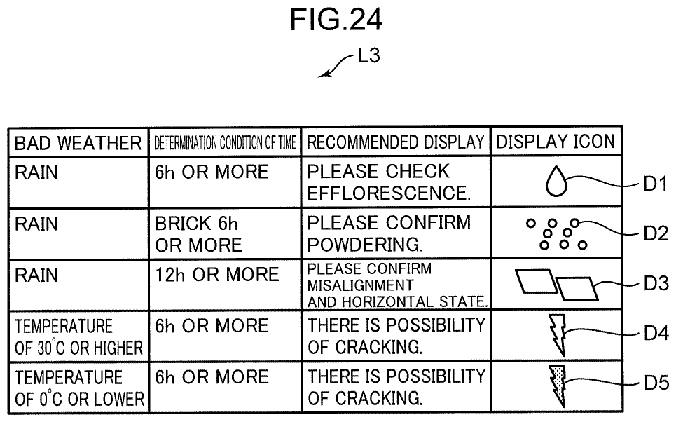

FIG. 15 is referred to. In addition to the determination according to the second embodiment, the determination unit 203 according to the third embodiment determines whether bad weather has continued for a predetermined time or more based on the weather information 400. Then, in a case where bad weather has continued for a predetermined time or more, the generation unit 107 generates the superimposed image IMS by superimposing recommended information 630 for recommending confirmation of a state of each of the plurality of construction members E on each of the plurality of construction members E included in the second image IM2 together with the color information 610. In the third embodiment, the “predetermined time” is decided based on recommended information list L3 (see FIG. 24) stored in advance in the storage unit 130.

FIG. 24 is a view illustrating an example of a data configuration of the recommended information list L3. The recommended information list L3 is a list that defines a determination condition as to whether to display the recommended information 630 for each construction member E.

The recommended information list L3 includes a column of “bad weather”, a column of “determination condition”, a column of “recommended display”, and a column of “display icon”. The column “bad weather” stores the kind of bad weather. In the column of “determination condition”, a detailed criterion (for example, duration or the like) for determination by the determination unit 203 is stored. Note that the numerical value of the duration stored in the column of “determination condition” in FIG. 24 is merely an example, and can be changed as appropriate.

In the column of “recommended display”, the intention of the recommended information 630 is stored. In the “display icon”, an icon indicating the recommended information 630 is stored. In the example of FIG. 24, icons D1 to D5 indicating the recommended information 630 are adopted. The icon D1 is an icon for prompting confirmation of efflorescence. The icon D2 is an icon for prompting confirmation of powdering. The icon D3 is an icon for prompting confirmation of the positional deviation and the horizontal state. The icon D4 is an icon for prompting confirmation of the possibility of cracking due to high temperature. The icon D5 is an icon for prompting confirmation of cracking due to a low temperature.

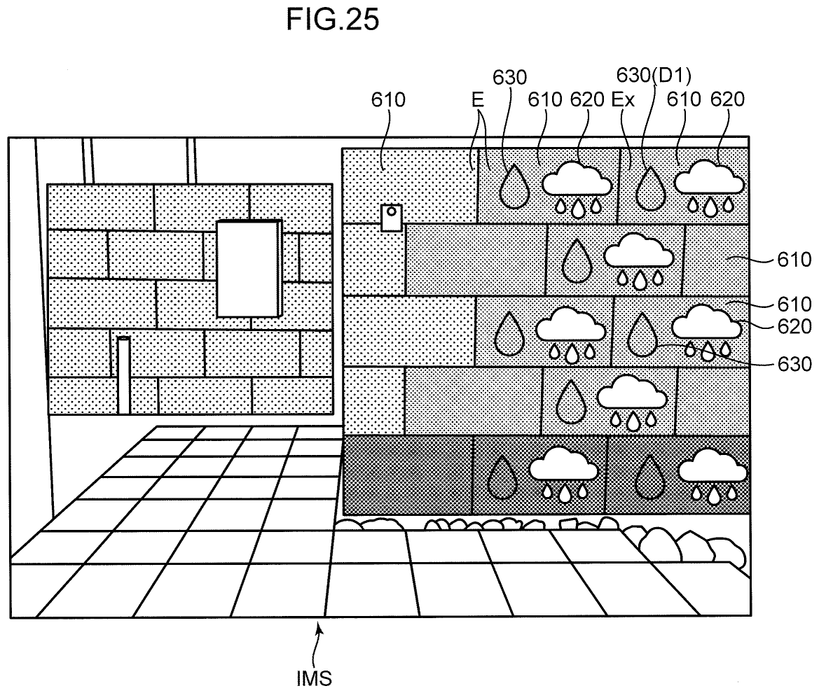

In the first row of the recommended information list L3, bad weather “rain” and a determination condition “6 h or more” are stored. Therefore, the determination unit 203 determines that the construction member Ex satisfies the determination condition of the first row in a case where the construction member Ex having the type (for example, tile) other than the brick is continuously raining for 6 hours or more between the installation date and time and the second imaging date and time. In this case, the generation unit 107 generates the superimposed image IMS by superimposing the recommended information 630 indicated by the icon D1 on the construction member Ex included in the second image IM2 together with the bad weather information 620 and the color information 610 (see FIG. 25). Note that the determination unit 203 may specify the time when it has continuously rained by referring to the weather information 400 at the work site where the construction member Ex is installed.

The bad weather “rain” and the determination condition “brick 6 h or more” are stored in the second row of the recommended information list L3. Therefore, the determination unit 203 determines that the construction member Ex satisfies the determination condition of the second row in a case where the construction member Ex having the type of brick is continuously raining for 6 hours or more between the installation date and time and the second imaging date and time. In this case, the generation unit 107 generates the superimposed image IMS by superimposing the recommended information 630 indicated by the icon D2 on the construction member Ex included in the second image IM2 together with the bad weather information 620 and the color information 610.

In the third row of the recommended information list L3, bad weather “rain” and a determination condition “12 h or more” are stored. Therefore, the determination unit 203 determines that the construction member Ex satisfies the determination condition of the third row in a case where the construction member Ex having the type (for example, tile) other than the brick is continuously raining for 12 hours or more between the installation date and time and the second imaging date and time. In this case, the generation unit 107 generates the superimposed image IMS by superimposing the recommended information 630 indicated by the icon D3 on the construction member Ex included in the second image IM2 together with the bad weather information 620 and the color information 610.

In the fourth row of the recommended information list L3, bad weather “temperature of 30 degrees or more” and a determination condition “6 h or more” are stored. Therefore, the determination unit 203 determines that a certain construction member Ex satisfies the determination condition in the fourth row in a case where the construction member Ex is continuously exposed for 6 hours or more under an environment where the temperature is 30° C. or higher between the installation date and time and the second imaging date and time. In this case, the generation unit 107 generates the superimposed image IMS by superimposing the recommended information 630 indicated by the icon D4 on the construction member Ex included in the second image IM2 together with the color information.

In the fifth row of the recommended information list L3, bad weather “temperature is 0 degrees or less” and a determination condition “6 h or more” are stored. Therefore, the determination unit 203 determines that a certain construction member Ex satisfies the determination condition in the fifth row in a case where the construction member Ex is continuously exposed for 6 hours or more under an environment where the temperature is 0° C. or lower between the installation date and time and the second imaging date and time. In this case, the generation unit 107 generates the superimposed image IMS by superimposing the recommended information 630 indicated by the icon D5 on the construction member Ex included in the second image IM2 together with the color information.

Note that the determination unit 203 according to the third embodiment determines whether each construction member E is arranged at a position affected by bad weather. Therefore, in the third embodiment, the superimposed image IMS in which the recommended information 630 is superimposed together with the bad weather information 620 and the color information 610 is generated only on each construction member E arranged at a position affected by bad weather.

Although not illustrated in detail, in a case where the bad weather has continued for a predetermined time or more, the generation unit 107 according to the third embodiment superimposes at least one of the installation date and time, the scheduled completion date and time, the type information, the adhesive information, and the base member information on each of the plurality of construction members E included in the second image IM2.

In addition, in a case where the generation unit 107 generates the bad weather information 620, the output unit 108 may cause the second display unit 23 to display an order button for ordering the construction member E. According to this configuration, the second worker who confirms the superimposed image IMS on which the bad weather information 620 is superimposed and grasps that some abnormality has occurred in the construction member E can immediately order the additional (new) construction member E.

In addition to or instead of the above-described various types of icons, the generation unit 107 may superimpose information stored in the column of “recommended display” on each of the plurality of construction members E as the recommended information 630.

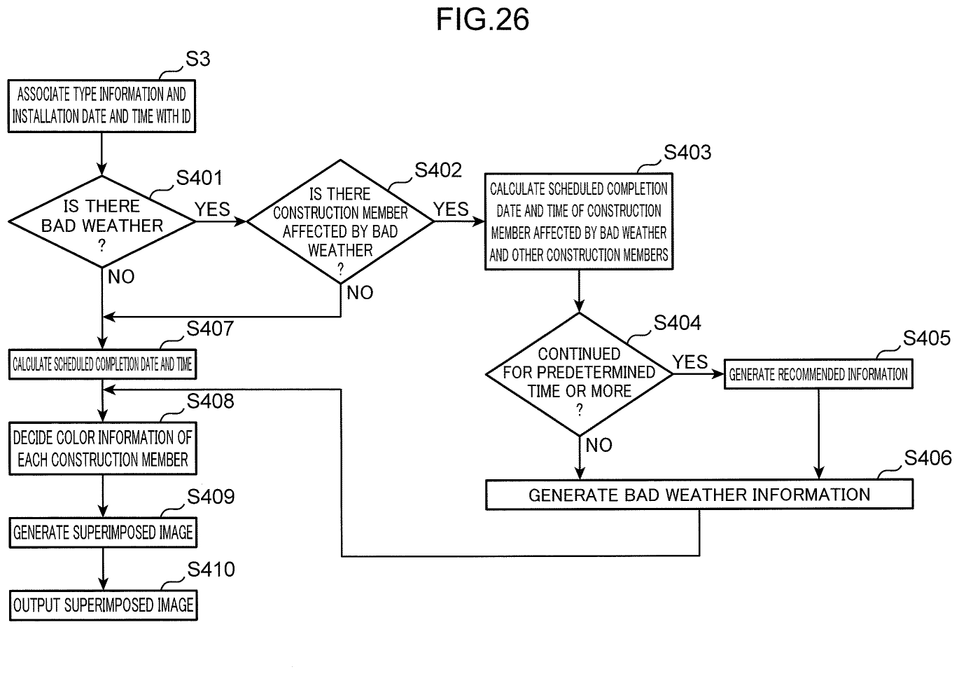

FIG. 26 is a flowchart illustrating an example of processing in the third embodiment. The flowchart of FIG. 26 illustrates processing after step S3 of the sequence diagram of FIG. 2.

Since the processing executed in steps S401 and S402 is similar to the processing executed in steps S101 and S102 in FIG. 21, the description thereof will be omitted.

### Step S403

The calculation unit 105 calculates the scheduled completion date and time of each construction member E affected by bad weather and the scheduled completion date and time of each construction member E not affected by bad weather. In the third embodiment, the method of calculating the scheduled completion date and time of each construction member E not affected by bad weather is the same as the method of calculating the scheduled completion date and time described in the first embodiment, and the method of calculating the scheduled completion date and time of each construction member E affected by bad weather is the same as the method of calculating the scheduled completion date and time described in the second embodiment (the method of referring to the column “completion time in case of bad weather” of the completion time list L2A).

### Step S404

The determination unit 203 determines whether bad weather has continued for a predetermined time or more based on the weather information 400. In a case where bad weather has continued for a predetermined time or more (YES in step S404), the processing of the information processing device 300 proceeds to step S405. In a case where bad weather has not continued for a predetermined time or more (NO in step S404), the processing of the information processing device 300 proceeds to step S406. For example, the determination unit 203 refers to the weather information 400 to specify the time when it has continuously rained between the installation date and time and the second imaging date and time for each construction member E. Then, the determination unit 203 may determine that bad weather has continued for a predetermined time or more if the specified time during which it has continuously rained is a predetermined time or more.

### Step S405

Based on the recommended information list L3 and the arrangement information, the generation unit 107 generates the recommended information 630 to be superimposed on each construction member E arranged at a position affected by bad weather. In this case, the generation unit 107 may specify an icon to be displayed as the recommended information 630 from the icons D1 to D5 according to the determination condition defined by the recommended information list L3 illustrated in FIG. 24.

Since the processing executed in steps S406 to S408 is similar to the processing executed in steps S104 to S106 in FIG. 21, the description thereof will be omitted.

### Step S409

The generation unit 107 generates the superimposed image IMS in which the color information 610 for each construction member E is superimposed on each construction member E in the second image IM2. At this time, the generation unit 107 superimposes the bad weather information 620 and the recommended information 630 together with the color information 610 on each construction member E arranged at a position affected by bad weather.

FIG. 25 is a view illustrating the superimposed image IMS on which the recommended information 630 is superimposed. For example, the construction member Ex is a tile on which it has continuously rained for 6 hours or more from the installation date and time to the second imaging date and time. Therefore, the recommended information 630 having the icon D1 on the color information 610 and the bad weather information 620 are superimposed on the construction member Ex.

Since the processing executed in step S410 is similar to the processing executed in step S108 in FIG. 21, the description thereof will be omitted.

As described above, according to the third embodiment, the superimposed image IMS on which the recommended information 630 is superimposed is presented to the second worker. Therefore, in a case where any abnormality has occurred in the construction member E due to bad weather continuing for a predetermined time or more, it is suppressed that the abnormality is overlooked.

### First Modification of Third Embodiment

In step S403 of the third embodiment, the scheduled completion date and time of each construction member E affected by bad weather is calculated using the same method as the method of calculating the scheduled completion date and time described in the second embodiment (the method of referring to the column of “completion time in case of bad weather” of the completion time list L2A). However, instead of this, the scheduled completion date and time may be calculated using the method of the first modification of the second embodiment.

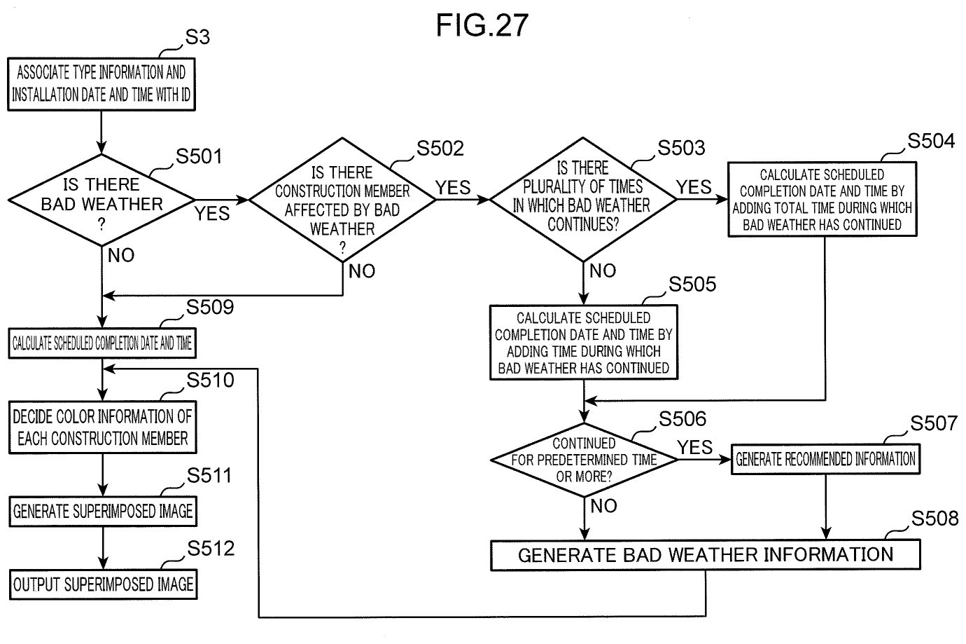

FIG. 27 is a flowchart illustrating an example of processing according to a first modification of the third embodiment. The flowchart of FIG. 27 illustrates processing after step S3 of the sequence diagram of FIG. 2. Further, since the processing executed in steps S501 to S505 is similar to the processing executed in steps S201 to S205 in FIG. 22, the description thereof will be omitted. In addition, since the processing executed in steps S506 to S512 is similar to the processing executed in steps S404 to S410 in FIG. 26, the description thereof will be omitted.

### Second Modification of Third Embodiment

In step S403 of the third embodiment, the scheduled completion date and time of each construction member E affected by bad weather is calculated using the same method as the method of calculating the scheduled completion date and time described in the second embodiment. However, instead of this, the scheduled completion date and time may be calculated using the method of the second modification of the second embodiment.

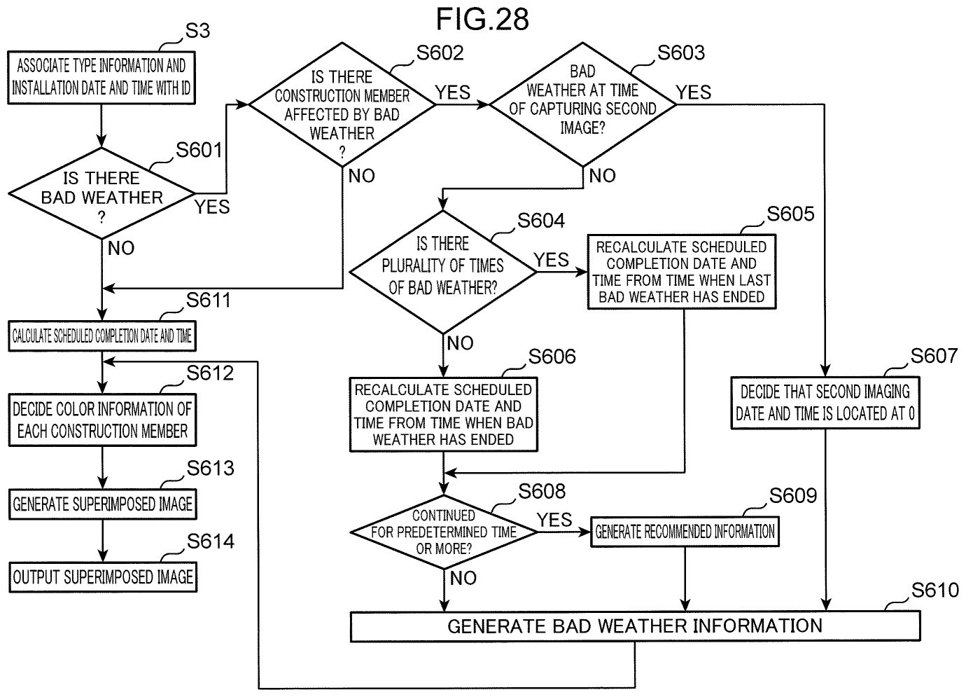

FIG. 28 is a flowchart illustrating an example of processing according to a second modification of the third embodiment. The flowchart of FIG. 28 illustrates processing after step S3 of the sequence diagram of FIG. 2. Further, since the processing executed in steps S601 to S607 is similar to the processing executed in steps S301 to S307 in FIG. 23, the description thereof will be omitted. In addition, since the processing executed in steps S608 to S614 is similar to the processing executed in steps S404 to S410 in FIG. 26, the description thereof will be omitted.

### Third Modification of Third Embodiment

The generation unit 107 may generate the superimposed image IMS in which the color information 610 is superimposed only on the construction member E satisfying the condition input by the second worker. In the present modification, a condition input form (not illustrated) for allowing the second worker to input a condition may be displayed on the second display unit 23 together with the superimposed image IMS. Alternatively, in a case where the second worker selects (touches) an arbitrary construction member E in the superimposed image IMS displayed on the second display unit 23, the selection may be regarded as condition input. For example, in a case where the second worker touches the construction member E of the type “TILE-a11”, the generation unit 107 may generate the superimposed image IMS in which the color information 610 is superimposed only on the construction member E of the type “TILE-a11”. Alternatively, for example, in a case where the second worker touches the construction member E arranged at a position affected by bad weather, the generation unit 107 may generate the superimposed image IMS in which the color information 610 and the bad weather information 620 are superimposed only on the construction member E arranged at a position affected by bad weather.

### Fourth Modification of Third Embodiment

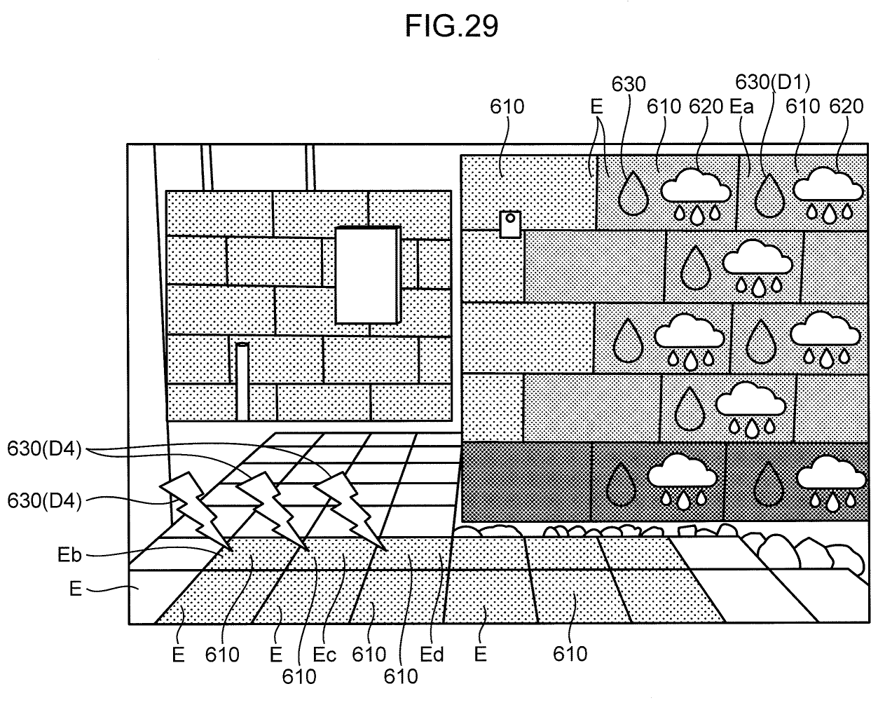

The generation unit 107 may decide the kind of information to be superimposed on each construction member E according to the setting input by the second worker. FIG. 29 is a view illustrating the superimposed image IMS in which the setting for the kind of information to be superimposed on the construction member E is input for each construction member E. For example, settings are input to a construction member Ea such that the color information 610, the bad weather information 620, and the recommended information 630 are displayed together. Here, the construction member Ea is a tile on which it has continuously rained for 6 hours or more from the installation date and time to the second imaging date and time. Therefore, the generation unit 107 superimposes the recommended information 630 having the icon D1 on the color information 610 and the bad weather information 620 on the construction member Ea. In addition, settings are input to each of the construction members Eb, Ec, and Ed such that the color information 610 and the recommended information 630 are displayed together, and the bad weather information 620 is not displayed. Here, the construction members Eb to Ed are exposed to an environment with a temperature of 30 degrees or more for 6 hours or more continuously from the installation date and time to the second imaging date and time. Therefore, the generation unit 107 generates the superimposed image IMS by superimposing the recommended information 630 indicated by the icon D4 on the color information 610 on these construction members Eb to Ed.

### INDUSTRIAL APPLICABILITY

According to the present disclosure, it is useful at a work site where a plurality of construction companies perform work in a divided manner.

1. An information processing method in an information processing device, the method comprising:
acquiring a first image obtained by capturing a plurality of bonding targets and an installation date and time of each of the plurality of bonding targets;
recognizing the plurality of bonding targets included in the first image;
acquiring a second image obtained by capturing the plurality of bonding targets after imaging of the first image and acquiring an imaging date and time when the imaging has been performed;
calculating a scheduled completion date and time of each of the plurality of bonding targets based on the installation date and time;
deciding, for each of the bonding targets, a position of the imaging date and time on a time axis from the installation date and time to the scheduled completion date and time, and deciding color information predetermined for the decided position;
generating a superimposed image in which the color information is superimposed on each of the plurality of bonding targets included in the second image based on a recognition result of the first image; and
outputting the superimposed image.

2. The information processing method according to claim 1, further comprising:
acquiring at least one of type information indicating a kind of each of the plurality of bonding targets, adhesive information related to an adhesive used for bonding of the plurality of bonding targets, and base member information related to a base member to which the plurality of bonding targets are bonded; and
calculating the scheduled completion date and time based on at least one of the type information, the adhesive information, and the base member information.

3. The information processing method according to claim 2, further comprising:
acquiring weather information; and
determining, based on the weather information, whether there is bad weather that affects completion of the plurality of bonding targets between the installation date and time and the imaging date and time,
wherein in the generating of the superimposed image, in a case where there is the bad weather, bad weather information indicating that there is the bad weather is superimposed on the plurality of bonding targets included in the second image.

4. The information processing method according to claim 3, wherein in the calculating of the scheduled completion date and time, in a case where there is the bad weather, the scheduled completion date and time reflecting an influence of the bad weather is calculated.

5. The information processing method according to claim 4, wherein in the calculating of the scheduled completion date and time, in a case where there is the bad weather, the scheduled completion date and time is calculated by adding a time during which the bad weather has continued to the scheduled completion date and time calculated in a case where there is no bad weather.

6. The information processing method according to claim 4, wherein
the bad weather is rain or snow, and
in the calculating of the scheduled completion date and time, in a case where there is the bad weather, an end time of the bad weather is set as the installation date and time.

7. The information processing method according to claim 4, further comprising determining whether the bad weather has continued for a predetermined time or more in a case where there is the bad weather,
wherein in the generating of the superimposed image, in a case where the bad weather has continued for a predetermined time or more, recommended information for recommending confirmation of a state of each of the plurality of bonding targets is superimposed on each of the plurality of bonding targets included in the second image.

8. The information processing method according to claim 7, wherein in the generating of the superimposed image, in a case where the bad weather has continued for a predetermined time or more, at least one of the installation date and time, the scheduled completion date and time, the type information, the adhesive information, and the base member information is superimposed on each of the plurality of bonding targets included in the second image.

9. The information processing method according to claim 3, further comprising:
acquiring arrangement information indicating arrangement of each bonding target at a work site where the plurality of bonding targets are bonded; and
determining, for each of the bonding targets, whether the bonding target is arranged at a position affected by the bad weather at the work site based on the arrangement information.

10. The information processing method according to claim 1, further comprising:
acquiring weather information; and
determining, based on the weather information, whether bad weather that affects completion of the plurality of bonding targets is predicted to come between the imaging date and time and the scheduled completion date and time,
wherein in the generating of the superimposed image, in a case where the bad weather is predicted to come, bad weather preparation information recommending preparation for the bad weather is superimposed on each of the plurality of bonding targets included in the second image.

11. The information processing method according to claim 10, further comprising:
acquiring arrangement information indicating arrangement of each bonding target at a work site where the plurality of bonding targets are bonded; and
determining, for each of the bonding targets, whether the bonding target is installed at a position affected by the bad weather at the work site based on the arrangement information.

12. The information processing method according to claim 1, further comprising calculating a load-bearing capacity of each of the plurality of bonding targets based on the scheduled completion date and time,
wherein in the generating of the superimposed image, load-bearing information indicating the load-bearing capacity is superimposed on each of the plurality of bonding targets included in the second image.

13. The information processing method according to claim 1, further comprising recognizing bonding targets installed at a common date and time among the plurality of bonding targets as a bonding target group,
wherein in the generating of the superimposed image, the second image is superimposed with distinction information for emphasizing distinction between the bonding target group and another bonding target group of bonding targets installed at a common date and time different from that of the bonding target group.

14. The information processing method according to claim 1, further comprising determining whether bonding of the bonding target is completed for each of the bonding targets,
wherein in the generating of the superimposed image, bonding completion information is superimposed on a bonding target determined to have been completely bonded among the plurality of bonding targets included in the second image.

15. The information processing method according to claim 14, further comprising acquiring at least one of type information indicating a kind of each of the plurality of bonding targets, adhesive information related to an adhesive used for bonding of the plurality of bonding targets, and base member information related to a base member to which the plurality of bonding targets are bonded,
wherein in the generating of the superimposed image, at least one of the installation date and time, the scheduled completion date and time, the type information, the adhesive information, and the base member information is superimposed on a bonding target determined to have been completely bonded among the plurality of bonding targets included in the second image.

16. The information processing method according to claim 1, wherein in the generating of the superimposed image, the color information is superimposed only on a bonding target that satisfies a condition input by a worker among the plurality of bonding targets included in the second image, and the color information is not superimposed on other construction members.

17. An information processing device comprising:
a first acquisition unit that acquires a first image obtained by capturing a plurality of bonding targets and an installation date and time of each of the plurality of bonding targets;
a recognition unit that recognizes the plurality of bonding targets included in the first image;
a second acquisition unit that acquires a second image obtained by capturing the plurality of bonding targets after imaging of the first image and acquires an imaging date and time when the imaging has been performed;
a calculation unit that calculates a scheduled completion date and time of each of the plurality of bonding targets based on the installation date and time;
a decision unit that decides, for each of the bonding targets, a position of the imaging date and time on a time axis from the installation date and time to the scheduled completion date and time, and decides color information predetermined for the decided position;
a generation unit that generates a superimposed image in which the color information is superimposed on each of the plurality of bonding targets included in the second image based on a recognition result of the first image; and
an output unit that outputs the superimposed image.

18. A non-transitory computer readable recording medium storing an information processing program causing a computer to execute:
acquiring a first image obtained by capturing a plurality of bonding targets and an installation date and time of each of the plurality of bonding targets;
recognizing the plurality of bonding targets included in the first image;
acquiring a second image obtained by capturing the plurality of bonding targets after imaging of the first image and acquiring an imaging date and time when the imaging has been performed;
calculating a scheduled completion date and time of each of the plurality of bonding targets based on the installation date and time;
deciding, for each of the bonding targets, a position of the imaging date and time on a time axis from the installation date and time to the scheduled completion date and time, and deciding color information predetermined for the decided position;
generating a superimposed image in which the color information is superimposed on each of the plurality of bonding targets included in the second image based on a recognition result of the first image; and
outputting the superimposed image.
